(19) United States
(12) Patent Application Publication
(10) Pub. No.: US 2013/0034162 A1
(43) Pub. Date: Feb. 7, 2013

(54) IMAGE PROCESSING APPARATUS AND IMAGE PROCESSING METHOD

(71) Applicant: Kazushi Sato, Kanagawa (JP)

(72) Inventor: Kazushi Sato, Kanagawa (JP)

(21) Appl. No.: 13/638,241

(22) PCT Filed: Mar. 28, 2011
(86) PCT No.: PCT/JP2011/057703

§ 371 Date: Sep. 28, 2012

(30) Foreign Application Priority Data
Apr. 6, 2010 (JP) 2010-088168

(51) Int. Cl. H04N 7/32

(52) U.S. Cl. 375/240.16; 375/E07.125

(57) ABSTRACT

The present invention relates to an image processing apparatus and an image processing method that can suppress increase of a processing amount and enhance a coding efficiency when prediction motion vector information is generated.

A motion vector information encoder 76 generates prediction motion vector information of a current block by using supplied peripheral motion vector information, and generates differential motion vector information of the current block which corresponds to the difference between the motion vector information and prediction motion vector information of the current block. Furthermore, the motion vector information encoder 76 generates secondary differential motion vector information of the current block which corresponds to the difference between the differential motion vector information of the current block and differential motion vector information of a corresponding block from a motion prediction/compensation unit 75. The generated differential motion vector information of the current block and the generated secondary differential motion vector information are supplied to the prediction/compensation unit 75. The present invention is applicable to an image encoding device for performing encoding based on H. 264/AVC system.

### TECHNICAL FIELD

The present invention relates to an image processing apparatus and an image processing method, and particularly to an image processing apparatus and an image processing method that can suppress increase of a processing amount and also enhance a coding efficiency when prediction motion vector information is generated.

### BACKGROUND ART

There has recently grown popular an apparatus that treats image information in a digital form and compresses and encodes an image by using an encoding system for performing compression based on orthogonal transform such as discrete cosine transform and motion compensation by using redundancy peculiar to image information so that information of high efficiency is transmitted and accumulated. This encoding system contains MPEG (Moving Picture Experts Group) or the like.

Particularly, MPEG2 (ISO/IEC 13818-2) is defined as a general-purpose image encoding system, and it is a standard covering both of an interlaced-scan image and a sequential scan image, a standard resolution image and a high-definition image. For example, MPEG2 has been presently widely used in a wide range of applications such as professional applications and consumer applications. By using the MPEG2 compression system, an encoding amount (bit rate) of 4 to 8 Mbps is allocated to an interlaced scan image having a standard resolution of 720×480 pixels, for example. Furthermore, by using the MPEG2 compression system, an encoding amount (bit rate) of 18 to 22 Mbps is allocated to an interlaced scan image having high resolution of 1920×1088 pixels. Accordingly, high compressibility and excellent image quality can be attained.

MPEG2 mainly targets high image quality encoding adapted to broadcasting, but it is not adapted to an encoding system having a lower encoding amount (bit rate), that is, higher compressibility than MPEG1. Needs for such an encoding system are expected to grow in the future due to popularization of cellular phones, and an MPEG4 encoding system has been standardized in connection with this. With respect to the image encoding system, the specification of the image encoding system has been approved as ISO/IEC 14496-2 by the International Standard in December 1998.

Recently, standardization of a standard called H. 26L (ITU-T Q6/16 VCEG) has been initially promoted for the purpose of image encoding for TV conference. It is known that a larger calculation amount is required for H. 26L as compared with conventional encoding systems such as MPEG2 and MPEG4 because of encoding and decoding, but a higher coding efficiency can be attained. Thereafter, standardization for attaining a higher coding efficiency by incorporating functions which are not supported by H. 26L has been executed as Joint Model of Enhanced-Compression Video Coding based on this H. 26L as an example of the activities related to MPEG4. As a standardization schedule, it has been internationally standardized as H. 264 and MPEG-4 Part 10 (Advanced Video Coding, hereinafter referred to as H. 264/AVC) on March 2003.

Furthermore, standardization of FRExt (Fidelity Range Extension) containing encoding tools such as RGBE, 4:2:2 and 4:4:4 required for business, 8×8 DOT defined in MPEG-2 and quantization matrix has been completed in February 2005 as an expansion. Accordingly, the encoding system has been capable of excellently expressing even film noise contained in movies by using H. 264/AVC, and so used in broad applications such as Blu-Ray Disc (trademark), etc.

However, there have recently grown needs for encoding of higher compressibility such as needs for compressing images of about 4000×2000 pixels corresponding to four times of high-definition television images or distributing high-definition television images in an environment having a limited transmission capacity such as the Internet or the like. Therefore, an improvement of the coding efficiency in VCEG (=Video Coding Expert Group) under the umbrella of ITU-T described above has been continually considered.

For example, motion prediction/compensation processing of ½ pixel precision is executed in the MPEG2 system by linear interpolation processing. On the other hand, prediction/compensation processing of ¼ pixel precision using FIR (Finite Impulse Response Filter) filter of 6 taps as an interpolation filter is executed in the H. 264/AVC system.

FIG. 1 is a diagram depicting the prediction/compensation processing of ¼ pixel precision in the H. 264/AVC system. The prediction/compensation processing of ¼ pixel precision using FIR (Finite Impulse Response Filter) filter of 6 taps is executed in the H. 264/AVC system.

In an example of FIG. 1, positions A represent positions of integer-number precision pixels, positions b, c and d represent positions of ½ pixel precision and positions e1, e2, e3 represent positions of ¼ pixel precision. In the following description, Clip( ) is first defined as the following formula (1).

$$\begin{matrix}[ Formula 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

When an input image is 8-bit precision, the value of max_pix is equal to 255.

The pixel values at the positions b and d are generated according to the following formula (2) by using the FIR filter of 6 taps.

### [Formula 2]

F=A₋₂−5A₋₁+20·A₀+20·A₁−5A₂+A₃b,d=Clip1((F+16)>>5) (2)

The pixel value at the position c is generated according to the following formula (3) by applying the FIR filter of 6 taps in the horizontal direction and the vertical direction.

### [Formula 3]

F=b₋₂−5·b₋₁+20·b₀+20·b₁−5·b₂+b₃

or

F=d₋₂−5d₋₁+20·d₀+20·d₁−5·d₂+d₃

c=Clip1((F+512)>>10) (3)

The Clip processing is lastly executed only once after the sum-of-products processing is executed in both the horizontal direction and the vertical direction.

The positions e1 to e3 are generated by linear interpolation according to the following formula (4)

### [Formula 4]

e₁=(A+b+1)>>1

e₂=(b+d+1)>>1

e₃=(b+c+1>>1 (4)

In the MPEG2 system, the motion prediction/compensation processing is executed on 16×16 pixels in the case of a frame motion compensation mode and executed on each of a first field and a second field every 16×8 pixels in the case of a field motion compensation mode.

On the other hand, in the motion prediction compensation of the H. 264/AVC system, the macro block size is equal to 16×16 pixels, but the motion prediction/compensation is executed while the block size is varied.

FIG. 2 is a diagram depicting an example of the block size of the motion prediction/compensation in the H. 264/AVC system.

An upper stage of FIG. 2 successively depicts, from the left side, macro blocks constructed by 16×16 pixels that are divided into partitions of 16×16 pixels, 16×8 pixels, 8×16 pixels and 8×8 pixels. A lower stage of FIG. 2 successively depicts, from the left side, partitions of 8×8 pixels that are divided into sub partitions of 8×8 pixels, 8×4 pixels, 4×8 pixels and 4×4 pixels.

That is, in the H. 264/AVC system, one macro block is divided into any partition of 16×16 pixels, 16×8 pixels, 8×16 pixels or 8×8 pixels so as to have each independent motion vector information. Furthermore, with respect to the partition of 8×8 pixels, it is divided into any sub partition of 8×8 pixels, 8×4 pixels, 4×8 pixels or 4×4 pixels so as to have each independent motion vector information.

Furthermore, the prediction/compensation processing of a multi-reference frame is also executed in the H. 264/AVC system.

FIG. 3 is a diagram depicting the prediction/compensation processing of the multi-reference frame in the H. 264/AVC system, in the H. 264/AVC system, the motion prediction/compensation system of the multi-reference frame (Multi-Reference Frame) is defined.

A current frame Fn to be encoded from now and frames Fn-5, . . . , Fn-1 which have been en coded are depicted in an example of FIG. 3. The frame Fn-1 is a frame just before the current frame Fn on the time axis, the frame Fn-2 is a frame preceding the current frame Fn over one frame, and the frame Fn-3 is a frame preceding the current frame Fn over two frames. Furthermore, the frame Fn-4 is a frame preceding the current frame Fn over three frames, and the frame Fn-5 is a frame preceding the current frame Fn over four frames. In general, as a frame is nearer to the current frame Fn on the time axis, the frame is added with a smaller reference picture number (ref_id). That is, the frame Fn-1 has the smallest reference picture number, and the reference picture numbers of the subsequent frames Fn-2, . . . , Fn-5 successively increase.

A block A1 and a block A2 are represented on the current frame Fn, and a motion vector V1 is searched on the assumption that the block A1 has a correlation with a block A1′ of the frame Fn-2 that is two frames before (precedes the current frame Fn over one frame). A motion vector V2 is searched on the assumption that the block A2 has a correlation with a block A1′ of the frame An-4 that is four frames before (precedes the current frame Fn over three frames).

As described above, in the H. 264/AVC system, plural reference frames may be stored in a memory, and different reference frames may be referred to for one frame (picture). That is, for example, each block can individually have independent reference frame information (reference picture number (ref_id)) on one picture such that the block A1 refers to the frame Fn-2 and the block A2 refers to the frame Fn-4.

Here, the block represents any partition of 16×16 pixels, 16×8 pixels, 8×16 pixels and 8×8 pixels described with reference to FIG. 2. The reference frames in the 8×8 sub blocks must be identical to one another.

As described above, the motion prediction/compensation processing of ¼ pixel precision described with reference to FIG. 1 and the motion prediction/compensation processing described above with reference to FIGS. 2 and 3 are executed in the H. 264/AVC system to generate a huge quantity of motion vector information. It causes reduction of the coding efficiency to directly encode the huge quantity of motion vector information. On the other hand, in the H. 264/AVC system, reduction of motion vector encoding information is performed by a method depicted in FIG. 4.

FIG. 4 is a diagram depicting a method of generating motion vector information based on the H. 264/AVC system.

A current block E (for example, 16×16 pixels) to be encoded from now and blocks A to D that have been already encoded and are adjacent to the current block E are represented in an example of FIG. 4

That is, the block DI is adjacently located at the upper left side of the current block E, the block B is adjacently located at the upper side of the current block E, the block C is adjacently located at the upper right side of the current block E and the block A is adjacently located at the left side of the current block E. The blocks A to D are not sectioned from one another, and this represents that each of these blocks is any one of the blocks constructed by the 16×16 pixels to 4×4 pixels described with reference to FIG. 2.

For example, motion vector information concerning X (=A, B, C, D, E) is represented by mv_{X}. First, prediction motion vector information pmv_{E} concerning the current block E is generated according to the following formula (5) based on median prediction by using the motion vector information concerning the blocks A, B, C.

pmv_{E}=med(mv_{A},my_{B},mv_{C}) (5)

There is a case where the motion vector information concerning the block C is not usable (is unavailable) because the block C is located at an end of a picture frame or has not yet been encoded. In this case, the motion vector information concerning the block C is substituted by the motion vector information concerning the block D.

Data mvd_{E} to be added to a header portion of a compressed image is generated as the motion vector information concerning the current block E according to the following formula (6) by using pmv_{E}

mvd_{E}=mv_{E}−pmv_{E} (6)

Actually, the processing is independently executed on each of the components in the horizontal direction and the vertical direction of the motion vector information.

As described above, the prediction motion vector information is generated, and the difference between the prediction motion vector information and the motion vector information generated based on the correlation with the adjacent block is added to the header portion, of the compressed image, thereby reducing the motion vector information.

The information amount of the motion vector information concerning a B picture is enormous, but a mode called a direct mode is prepared in the H. 264/AVC system. In the direct mode, the motion vector information is not stored in the compressed image.

That is, at a decoding side, the motion vector information of the current block is extracted from the motion vector information of the periphery of the current block or the motion vector information of a co-located block which is a block having the same coordinate as the current block in the reference picture. Accordingly, it is unnecessary to transmit the motion vector information to the decoding side.

Two kinds of modes of a spatial direct mode (Spatial Direct Mode) and a temporal direct mode (Temporal Direct Mode) exist as the direct mode. The spatial direct mode is a mode which mainly uses the correlation of the motion information in the spatial direction (two dimensional space of horizontal and vertical directions in a picture), and it is generally effective to an image that contains similar motions and varies in motion speed. On the other hand, the temporal direct mode is a mode which mainly uses the correlation of the motion information in the time direction, and it is generally effective to an image that contains different motions and is fixed in motion speed.

Which one of the spatial direct mode and the temporal direct mode is used can be switched every slice.

Referring to FIG. 4 again, the spatial direct mode based on the H. 264/AVC system will be described. As described above, the current block E (for example, 16×16 pixels) to be encoded from now and the blocks A to D which have been already encoded and are adjacent to the current block E are represented in the example of FIG. 4. For example, the motion vector information concerning X (=A, B, C, D, E) is represented by mvX.

The prediction motion vector information pmvE concerning the current block E is generated according to the foregoing formula (5) based on the median prediction by using the motion vector information concerning the blocks A, B, C, the motion vector information mvE concerning the current block E in the spatial direct mode is represented by the following formula (7)

mvE=pmvE (7)

That is, in the spatial direct mode, the prediction motion vector information generated based the median prediction is set as the motion vector information of the current block. That is, the motion vector information of the current block is generated by the motion vector information of the blocks that have been encoded. Accordingly, the motion vector based on the spatial direct mode can be also generated at the decoding side, so that it is unnecessary to transmit the motion vector information.

Next, the temporal direct mode in the H. 264/AVC system will be described with reference to FIG. 5.

In an example of FIG. 5, the time axis t represents time lapse, and an L0 (List0) reference picture, a current picture to be encoded from now and an L1 (List1) reference picture are successively represented from the left side. The arrangement of the L0 reference picture, the current picture and the L1 reference picture is not limited to this order in the H. 264/AVC system.

The current block of the current picture is contained in a B slice, for example. Accordingly, with respect to the current block of the current picture, L0 motion vector information mvL0 and L1 motion vector information mvL1 based on the temporal direct mode are calculated for the L0 reference picture and the L1 reference picture.

Furthermore, in the L0 reference picture, the motion vector information mvcol at a co-located block located at the same spatial address (coordinate) as the current block to be encoded from now is calculated based on the L0 reference picture and the L1 reference picture.

Here, the distance on the time axis between the current picture and the L0 reference picture is represented by TDB, and the distance on the time axis between the L0 reference picture and the L1 reference picture is represented by TDD. In this case, the L0 motion vector information mvL0 in the current picture and the L1 motion vector information mvL1 in the current picture can be calculated according to the following formula (8)

$$\begin{matrix}[ Formula 5 ] & \\ {mv}_{L 0} = \frac{{TD}_{B}}{{TD}_{D}} {mv}_{col} \\ {mv}_{L 1} = \frac{{TD}_{D} - {TD}_{B}}{{TD}_{D}} {mv}_{col} & ( 8 )\end{matrix}$$

In the H. 264/AVC system, the information corresponding to the distances TDB, TDD on the time axis t with respect to the current picture does not exist in the compressed image. Accordingly, POC (Picture Order Count) which is information representing the output order of pictures is used as actual values of the distances TDB, TDD.

Furthermore, in the H. 264/AVC system, the direct mode can be defined every macro block of 16×16 pixels or every block of 8×8 pixels.

The median prediction described with reference to FIG. 4 cannot necessarily perform coding of motion vectors with high efficiency. Therefore, Non-patent Document 1 or the like has proposed that the median prediction is not merely performed, but case classification is performed in accordance with the value of peripheral motion vector information so that prediction motion vector information is generated through the processing complying with the case classification.

The figures and the formulas described above are arbitrarily used in the description of this application.

### CITATION LIST

### Non-Patent Document

Non-patent Document 1: “A new method for improving motion vector coding”, VCEG-AJ14, ITU-Telecommunications Standardization Sector STUDY GROUP 16 Question 6, October 2008

### SUMMARY OF THE INVENTION

### Problems to be Solved by the Invention

A frame concerned in which a black elliptical object moves rightwards at a speed v on a screen with respect to the background as a still image area is represented in an example of FIG. 6. As depicted in FIG. 6, a block X concerned exists in a boundary area between the elliptical moving object and the still image area as the background. Adjacent blocks A, B and C that are adjacently located at the left side, upper side and upper right side of the block X concerned also exist in the boundary area.

When MVK represents motion vector information concerning the block K, the motion vector information of each of the adjacent blocks A, B and C is represented by the following formula (9) in the example of FIG. 6.

MVA=0;MVB=v;MVC=v;MVX=0 (9)

In this case, the prediction motion vector information of the block X is represented according to the following formula (10) by performing the median prediction of the foregoing formula (5)

Median(MVA,MVB,MVC)=Median(0,v,v)=v (10)

Since this is a value different from the actual MVX represented by the formula (9), the coding efficiency is lowered.

It is considered to apply the method proposed in Non-patent Document 1. However, the method proposed in Non-patent Document 1 requires a huge processing amount due to conditional branching.

The present invention has been attained in view of such a situation, and can suppress increase of the processing amount and enhance the coding efficiency when prediction motion vector information is generated.

### Solutions to Problems

An image processing apparatus according to a first aspect of the present invention includes: differential motion vector generating means that generates differential motion vector information of an encoding target block in an encoding target frame corresponding to a difference between motion vector information searched for the encoding target block in the encoding target frame and prediction motion vector information of the encoding target block; and secondary differential motion vector generating means that generates secondary differential motion vector information corresponding to a difference between differential motion vector information of the encoding target block generated by the differential motion vector generating means and differential motion vector information of a corresponding block that is a block of a reference frame and located at a position corresponding to the encoding target block.

Prediction motion vector generating means that generates prediction motion vector information of the encoding target block according to median prediction in the encoding target frame may be further provided.

The secondary differential motion vector generating means may generate the secondary differential motion vector information while the differential motion vector information of the corresponding block is set to zero when the corresponding block is an intra-predicted block.

There may be further provided encoding means that encodes the secondary differential motion vector information generated by the secondary differential motion vector generating means and an image of the encoding target block, and transmitting means that transmits the secondary differential motion vector information and the image of the encoding target block which have been encoded by the encoding means.

There may be further provided encoding means that selects any one of the differential motion vector information of the encoding target block generated by the differential motion vector generating means and the secondary differential motion vector information generated by the secondary differential motion vector generating means, and encodes the selected information and the image of the encoding target block, and transmitting means that transmits the information encoded and the image of the encoding target block which have been encoded by the encoding means.

The transmitting means further may transmit flag information as to which one of the differential motion vector information of the encoding target block and the secondary differential motion vector information has been selected and encoded.

The encoding means may adaptively select one of the differential motion vector information of the encoding target block and the secondary differential motion vector information.

The encoding means may select any one of the differential motion vector information of the encoding target block and the secondary differential motion vector information in accordance with a profile in an encoding parameter.

According to an image processing method of a first aspect of the present invention, in an image processing apparatus having differential motion vector generating means and secondary differential motion vector generating means, the differential motion vector generating means generates differential motion vector information of an encoding target block in an encoding target frame corresponding to a difference between motion vector information searched for the encoding target block in the encoding target frame in the encoding target frame and prediction motion vector information of the encoding target block; and secondary differential motion vector generating means generates secondary differential motion vector information corresponding to a difference between differential motion vector information of the encoding target block generated by the differential motion vector generating means and differential motion vector information of a corresponding block that is a block of a reference frame and located at a position corresponding to the encoding target block.

An image processing apparatus according to a second aspect of the present invention includes: receiving means that receives an image of a decoding target block in a decoding target frame and secondary differential motion vector information; and motion vector generating means that generates motion vector information of the decoding target block by using the secondary differential motion vector information received by the receiving means, prediction motion vector information of the decoding target block and differential motion vector information of a corresponding block that is a block of a reference frame and located at a position corresponding to the encoding target block.

Prediction motion vector generating means that generates prediction motion vector information of the decoding target block according to median prediction in the decoding target frame may be further provided.

The motion vector generating means may generate the motion vector information of the decoding target block while the differential motion vector information of the corresponding block is set to zero when the corresponding block is an intra-predicted block.

The receiving means may further receive flag information as to which one of the differential motion vector information of the decoding target block and the secondary differential motion vector information has been encoded, and receive the secondary differential motion vector information when the flag information represents that the secondary differential motion vector information has been encoded.

The receiving means may receive the differential motion vector information when the flag information represents that the differential motion vector information of the decoding target block is encoded, and the motion vector generating means may generate the motion vector information of the decoding target block by using the differential motion vector information of the decoding target block received by the receiving means and the prediction motion vector information of the decoding target block generated by the prediction motion vector generating means.

Any one of the differential motion vector information of the decoding target block and the secondary differential motion vector information is adaptively selected and encoded.

Any one of the differential motion vector information of the decoding target block and the secondary differential motion vector information is selected and encoded in accordance with a profile in an encoding parameter.

According to an image processing method of a second aspect of the present invention, in an image processing apparatus having receiving means and motion vector generating means, the receiving means receives an image of a decoding target block in a decoding target frame and secondary differential motion vector information, and the motion vector generating means generates motion vector information of the decoding target block by using the received secondary differential motion vector information, prediction motion vector information of the decoding target block and differential motion vector information of a corresponding block that is a block of a reference frame and located at a position corresponding to the encoding target block.

In the first aspect of the present invention, the differential motion vector information of the encoding target block which is the difference between the motion vector information searched for the encoding target block in the encoding target frame and the prediction motion vector information of the encoding target block is generated. The secondary differential motion vector which is the difference between the generated differential motion vector information of the encoding target block and the differential motion vector information of the corresponding block which is a block of a reference frame and located at a position corresponding to the encoding target block is generated.

In the second aspect of the present invention, the image of the decoding target block in the decoding target frame and the secondary differential motion vector information are received. The motion vector information of the decoding target block is generated by using the received secondary differential motion vector information, the prediction motion vector information of the decoding target block and the differential motion vector information of the corresponding block which is a block of a reference frame and located at a position corresponding to the encoding target block.

Each of the image processing apparatuses described above may be an independent apparatus or internal blocks constituting one image encoding device or image decoding device.

### Effects of the Invention

According to the present invention, the increase of the processing amount can be suppressed and the coding efficiency can be enhanced when the prediction motion vector information is generated.

### BRIEF DESCRIPTION OF DRAWINGS

FIG. 1 is a diagram depicting motion prediction/compensation processing of ¼ pixel precision.

FIG. 2 is a diagram depicting variable block size motion prediction/compensation processing.

FIG. 3 is a diagram depicting a motion prediction/compensation system of a multi-reference frame.

FIG. 4 is a diagram depicting an example of a method of generating motion vector information.

FIG. 5 is a diagram depicting a temporal direct mode.

FIG. 6 is a diagram depicting an example of a method of generating prediction motion vector information.

FIG. 7 is a block diagram depicting the construction of an embodiment of an image encoding device to which the present invention is applied.

FIG. 8 is a diagram depicting a case where a current block is located between a moving picture area and a still image area.

FIG. 9 is a diagram depicting a case where the current block is located between still image areas.

FIG. 10 is a block diagram depicting the constructions of a motion prediction/compensation unit and a motion vector information encoder of FIG. 7.

FIG. 11 is a flowchart depicting encoding processing of the image encoding device of FIG. 7.

FIG. 12 is a flowchart depicting intra prediction processing of step S21 of FIG. 11.

FIG. 13 is a flowchart depicting inter motion prediction processing of step S22 of FIG. 11.

FIG. 14 is a flowchart depicting secondary differential motion vector information generating processing of step S53 of FIG. 13.

FIG. 15 is a block diagram depicting the construction of an embodiment of an image decoding device to which the present invention is applied.

FIG. 16 is a block diagram depicting the constructions of a motion prediction/compensation unit and a motion vector information decoder of FIG. 15.

FIG. 17 is a flowchart depicting decoding processing of the image decoding device of FIG. 15.

FIG. 18 is a flowchart depicting prediction processing of step S138 of FIG. 17.

FIG. 19 is a diagram depicting an example of an expanded macro block.

FIG. 20 is a block diagram depicting an example of the construction of hardware of a computer.

FIG. 21 is a block diagram depicting an example of the main construction of a television receiver to which the present invention is applied.

FIG. 22 is a block diagram depicting an example of the main construction of a cellular phone to which the present invention is applied.

FIG. 23 is a block diagram depicting an example of the main construction of a hard disk recorder to which the present invention is applied.

FIG. 24 is a block diagram depicting an example of the main construction of a camera to which the present invention is applied.

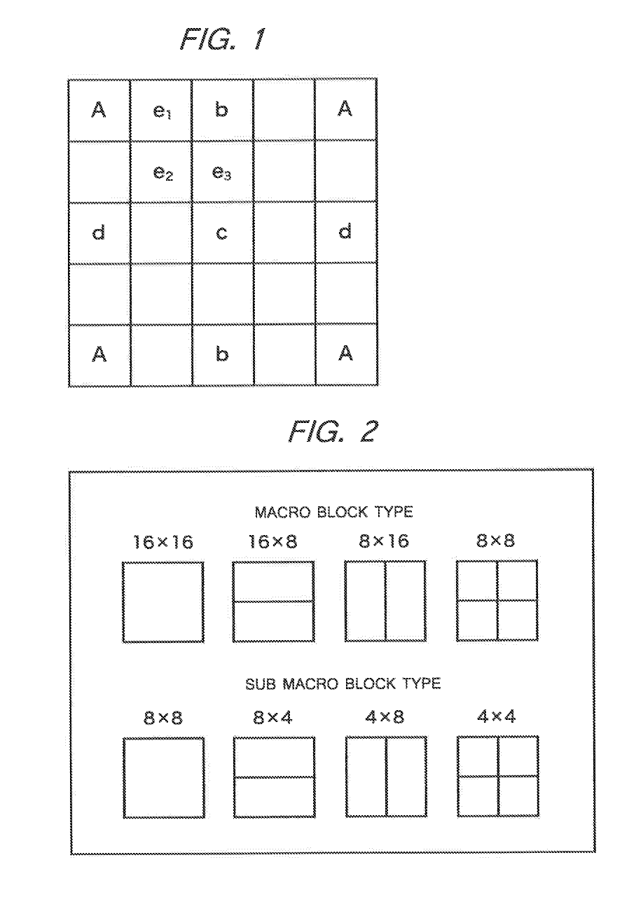

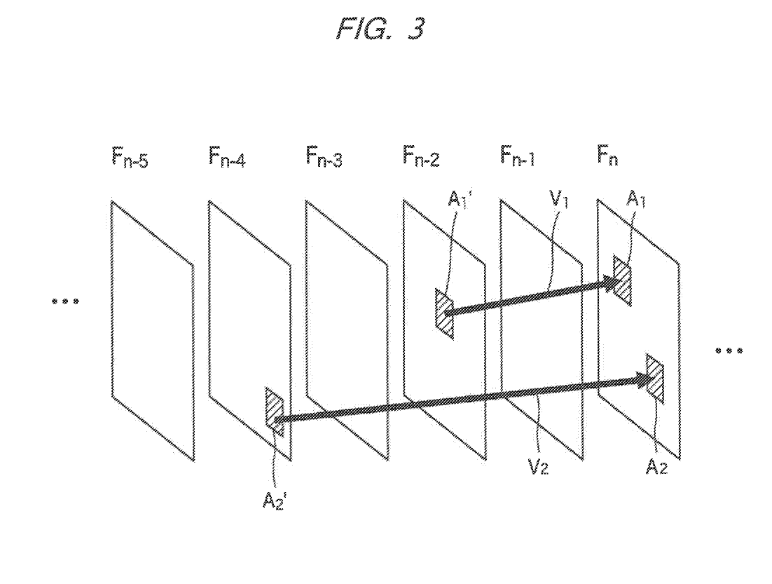

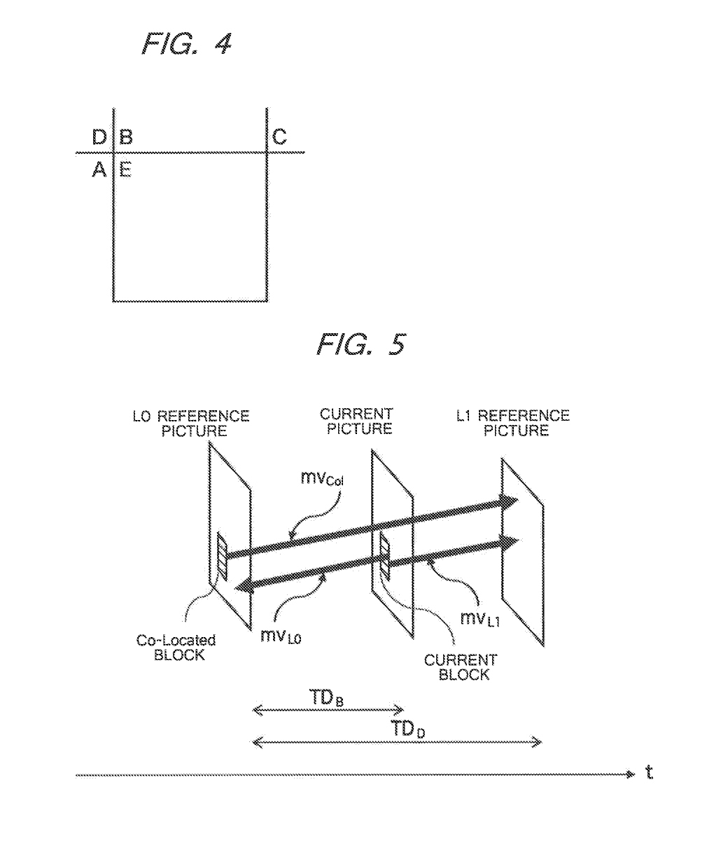

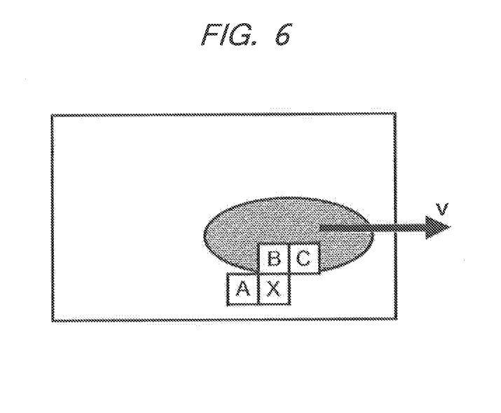

### MODE FOR CARRYING OUT THE INVENTION

Embodiments according to the present invention will be described hereunder with reference to the drawings.

### [Example of Construction of Image Encoding Device]

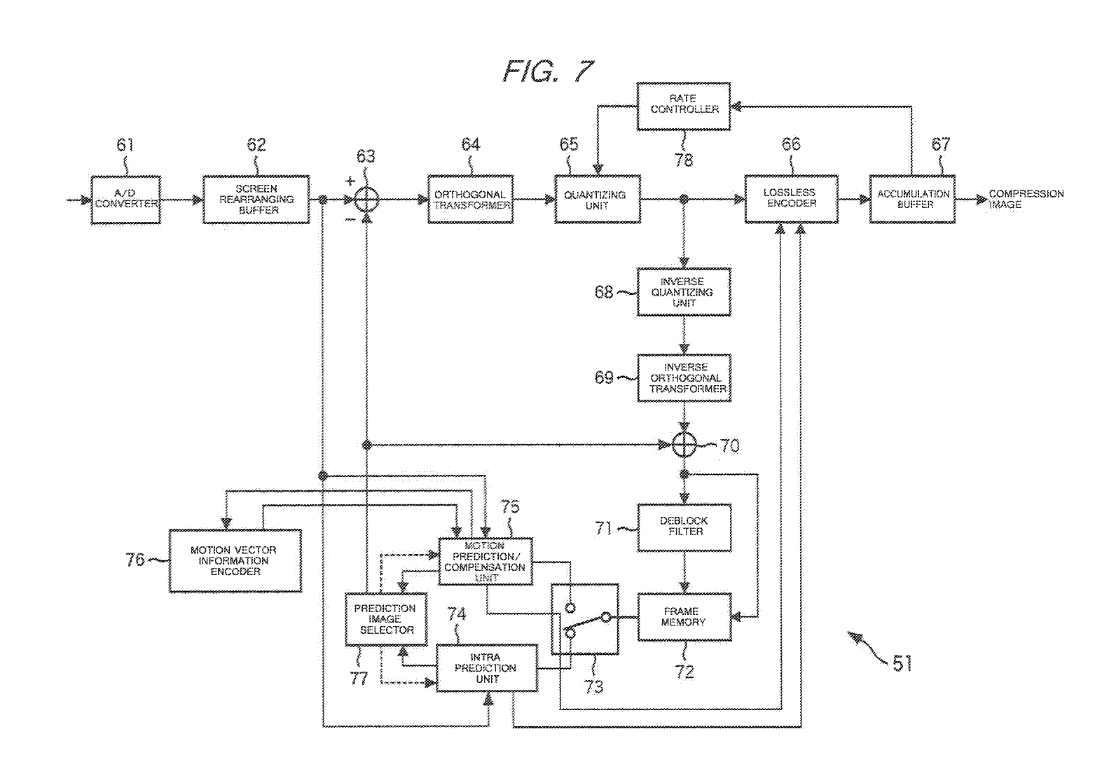

FIG. 7 depicts the construction of an embodiment of an image encoding device as an image processing apparatus to which the present invention is applied.

The image encoding device 51 executes compression coding on an image based on H. 264 and MPEG-4 Part 10 (Advanced Video Coding) (hereinafter referred to as 264/AVC) system, for example. That is, a motion compensation block mode defined in the H. 264/AVC system is used in the image encoding device 51.

In an example of FIG. 7, the image encoding device 51 is constructed by an A/D converter 61, a screen rearranging buffer 62, a calculator 63, an orthogonal transformer 64, a quantizing unit 65, a lossless encoder 66, an accumulation buffer 67, an inverse quantizing unit 68, an inverse orthogonal transformer 69, a calculator 70, a deblock filter 71, a frame memory 72, a switch 73, an intra prediction unit 74, a motion prediction/compensation unit 75, a motion vector information encoder 76, a prediction image selector 77 and a rate controller 78.

The A/D converter 61 subjects an input image to A/D conversion, and outputs the image to the screen rearranging buffer 62 to store the image in the screen rearranging buffer 62. The screen rearranging buffer 62 rearranges the stored images of frames arranged in a display order into the images of frames arranged for coding in accordance with GOP (Group of Picture).

The calculator 63 subtracts, from an image read from the screen rearranging buffer 62, a prediction image from the intra prediction unit 74 or a prediction image from the motion prediction/compensation unit 75 which is selected by the prediction image selector 77, and outputs the differential information therebetween to the orthogonal transformer 64. The orthogonal transformer 64 subjects the differential information from the calculator 63 to orthogonal transform such as discrete cosine transform or Karhunen-Loeve transform, and outputs the transform coefficient thereof. The quantizing unit 65 quantizes the transform coefficient output by the orthogonal transformer 64.

The quantized transform coefficient as an output of the quantizing unit 65 is input to the lossless encoder 66, and subjected to lossless coding such as variable-length coding or arithmetic coding to be compressed.

The lossless encoder 66 obtains information representing intra prediction from the intra prediction unit 74, and obtains information representing the inter prediction mode or the like from the motion prediction/compensation unit 75. The information representing the intra prediction and the information representing the inter prediction are also hereinafter referred to as intra prediction mode information and inter prediction mode information.

The lossless encoder 66 encodes the quantized transform coefficient and also encodes the information representing the intra prediction, the information representing the inter prediction mode and the like to set them as a part of header information in the compressed image. The lossless encoder 66 supplies and accumulates the encoded data into the accumulation buffer 67.

For example, the lossless coding processing such as the variable-length coding or the arithmetic coding is executed in the lossless encoder 66. CAVLC (Context-Adaptive Variable Length Coding) defined in the H. 264/AVC system and the like are known as the variable-length coding. CABAC (Context-Adaptive Binary Arithmetic Coding) and the like are known as the arithmetic coding.

The accumulation buffer 67 outputs the date supplied from the lossless encoder 66 as a compressed image encoded by the H. 264/AVC system to an image decoding device at the subsequent stage, a recording device, a transmission path and the like (not depicted).

The quantized transform coefficient output from the quantizing unit 65 is also input to the inverse quantizing unit 68 to be inversely quantized, and then subjected to inverse orthogonal transform in the inverse orthogonal transformer 69. The inverse orthogonal transform output is added with the prediction image supplied from the prediction image selector 77 by the calculator 70, and becomes a locally decoded image. The deblock filter 71 supplies and accumulates the decoded image into the frame memory 72 after removing block distortion of the decoded image. An image before deblock filter processing is also supplied and accumulated into the frame memory 72 by the deblock filter 71.

The switch 73 outputs reference images accumulated in the frame memory 72 to the motion prediction/compensation unit 75 or the intra prediction unit 74.

In the image encoding device 51, an I picture, a B picture and a P picture from the screen rearranging buffer 62 as images to be subjected to intra prediction (also called intra processing) are supplied to the intra prediction unit 74. Furthermore, the B picture and the P picture read from the screen rearranging buffer 62 are supplied as images to be subjected to inter prediction (also called inter processing) to the motion prediction/compensation unit 75.

The intra prediction unit 74 executes intra prediction processing of all intra prediction modes as candidates based on images which are read from the screen rearranging buffer 62 and are to be subjected to intra prediction and reference images supplied from the frame memory 72, thereby generating prediction images. At this time, the intra prediction unit 74 calculates cost function values for all the intra prediction modes as the candidates, and selects, as an optimum intra prediction mode, an intra prediction mode whose cost function value provides the minimum value.

The intra prediction unit 74 supplies the prediction image generated in the optimum intra prediction mode and the cost function value thereof to the prediction image selector 77. When the prediction image generated in the optimum intra prediction mode is selected by the prediction image selector 77, the intra prediction unit 74 supplies the information representing the optimum intra prediction mode to the lossless encoder 66. The lossless encoder 66 encodes this information and sets the information as a part of the header information in the compressed image.

The motion prediction/compensation unit 75 is supplied with images which are read from the screen rearranging buffer 62 and are to be subjected to inter processing and also supplied with reference images from the frame memory 72 through the switch 73. The motion prediction/compensation unit 75 performs motion search (prediction) of all inter prediction modes as candidates, and subjects the reference images to compensation processing by using the searched motion vectors, thereby generating prediction images.

The motion prediction/compensation unit 75 supplies the motion vector information encoder 76 with the motion vector information of the searched encoded current block the motion vector information of peripheral blocks of the current block and the differential motion vector information of a corresponding block (co-located block). The motion prediction/compensation unit 75 calculates the cost function values for all the inter prediction modes as the candidates by using the secondary differential motion vector information from the motion vector information encoder 76.

Here, the corresponding block is a block of an encoded frame (a frame located before or after) which is different from the current frame and located at a position corresponding to the current block.

The motion prediction/compensation unit 75 determines, as the optimum inter prediction mode, an inter prediction mode whose cost function value provides the minimum value in the respective blocks of the respective inter prediction modes as the candidates. The motion prediction/compensation unit 75 supplies the prediction image selector 77 with the prediction image generated in the optimum inter prediction mode and the cost function value thereof.

When the prediction image generated in the optimum inter prediction mode is selected by the prediction image selector 77, the motion prediction/compensation unit 75 outputs the information representing the optimum inter prediction mode (inter prediction mode information) to the lossless encoder 66.

At this time, the secondary differential motion vector information and the like are output to the lossless encoder 66. The lossless encoder 66 likewise subjects the information from the motion prediction/compensation unit 75 to the lossless coding processing such as the variable-length coding or the arithmetic coding, and inserts the processed information into the header portion of the compressed image.

From the motion prediction/compensation unit 75, the motion vector information encoder 76 is supplied with not only the motion vector information of the current block, but also the peripheral motion vector information which has been already obtained in the peripheral blocks of the current block and the differential motion vector information of the corresponding block. The peripheral blocks are blocks which are located circumferentially not only in space, but also in time-space, that is, the peripheral blocks contain blocks located on the spatial periphery of a frame located just before the current frame in time.

The motion vector information encoder 76 generates the prediction motion vector information of the current block by using the supplied peripheral motion vector information according to the median prediction of the foregoing formula (5) or the like. Furthermore, the motion vector information encoder 76 generates the differential motion vector information of the current block that corresponds to the difference between the motion vector information and the prediction motion vector information of the current block like the foregoing formula (6). Moreover, the motion vector information encoder 76 generates the secondary differential motion vector information of the current block that corresponds to the difference between the differential motion vector information of the current block and the differential motion vector information of the corresponding block from the motion prediction/compensation unit 75. The generated differential motion vector information and secondary differential motion vector information of the current block are supplied to the motion prediction/compensation unit 75.

The prediction image selector 77 determines the optimum prediction mode from the optimum intra prediction mode and the optimum inter prediction mode based on the respective cost function values output from the intra prediction unit 74 or the motion prediction/compensation unit 75. The prediction image selector 77 selects the prediction image of the determined optimum prediction mode, and supplies the prediction image to the calculators 63 and 70. At this time, the prediction image selector 77 supplies the selection information of the prediction image to the intra prediction unit 74 or the motion prediction/compensation unit 75.

The rate controller 78 controls the rate of the quantization operation of the quantizing unit 65 based on the compressed images accumulated in the accumulation buffer 67 so that neither overflow nor underflow occurs.

The processing target frame and block are arbitrarily referred to as a current frame and a current block, or a frame concerned and a block concerned respectively, and they have the same meanings.

### DESCRIPTION OF SUMMARY OF THE INVENTION

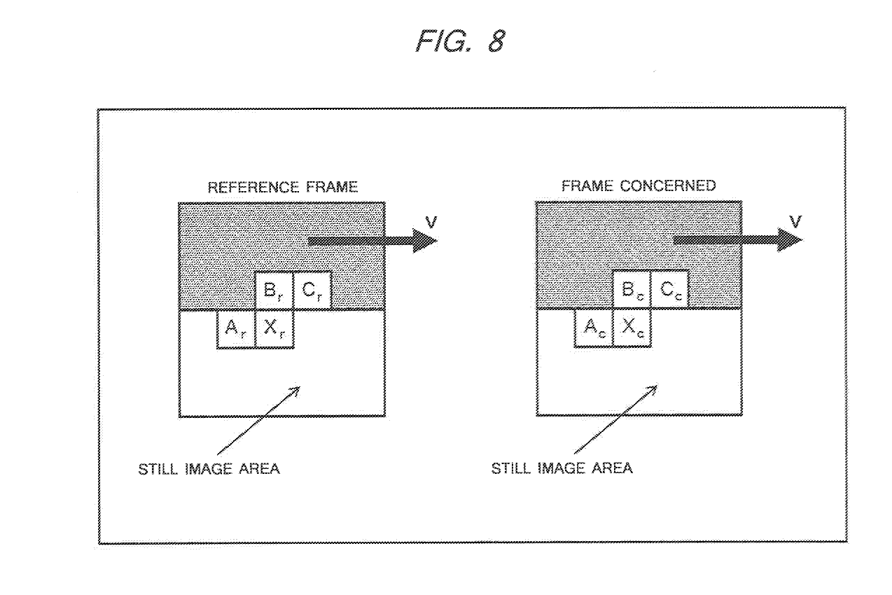

Next, the summary of the present invention will be described with reference to FIG. 8. A reference frame and a frame concerned are depicted in an example of FIG. 8. With respect to the reference frame and the frame concerned in FIG. 8, upper halves of the frames move at a speed v, and lower halves of the frames are still image areas.

A block X_{c} concerned and adjacent blocks A_{c}, B_{c}, C_{c} which are located adjacently at the left, upper and upper right sides of the block X_{c} concerned are depicted on the frame concerned. Furthermore, a corresponding block (co-located block) Xᵣ of the block X_{c} concerned and adjacent blocks Aᵣ, Bᵣ, Cᵣ which are located adjacently at the left, upper and upper right sides of the corresponding block Xᵣ are depicted on the reference frame.

When MVK represents the motion vector information concerning a block K, the motion vector information of each block in the example of FIG. 8 is represented by the following formula (11)

MVX_{c}=MVXᵣ=0

MVA_{c}=MVAᵣ=0

MVB_{c}=MVBᵣ=MVC_{c}=MVCᵣ=v (11)

At this time, the prediction motion vector information pmvᵣ in the corresponding block of the reference frame is represented by the following formula (12), and the differential motion vector information mvdᵣ corresponding to the difference between the prediction motion vector information and the motion vector information in the corresponding block is represented by the following formula (13).

pmvᵣ=Median(MVAᵣ,MVBᵣ,MVCᵣ)=Median(0,v,v)=v (12)

mvdᵣ=MVXᵣ,pmvᵣ=0v=−v (13)

Furthermore, the prediction motion vector information pmv_{c} in the block concerned of the frame concerned is represented by the following formula (14), and the differential motion vector information mvd_{c} corresponding to the difference between the prediction motion vector information and the motion vector information in the block concerned is represented by the following formula (15).

pmv_{c}=Median(MVA_{c},MVB_{c},MVC_{c})=Median(0,v,v)=v (14)

mvd_{c}=MVX_{c}pmv_{c}=0v=−v (15)

As described above, in the example of FIG. 8, the efficiency based on the median prediction is not good in both the reference frame and the frame concerned.

On the other hand, in the image encoding device 51, the secondary differential motion vector information mvdd represented by the following formula (16) is encoded as the motion vector information in the block concerned to be transmitted to the decoding side.

mvdd=mvd_{c}−mvdᵣ (16)

In the case of the example of FIG. 8, the secondary differential motion vector information mvdd is represented by the following formula (17)

mvdd=−v(−v)=0 (17)

Accordingly, even when the block concerned exists between the moving area and the still image area as in the case of the example of FIG. 8, a higher coding efficiency can be obtained as compared with the mere median prediction.

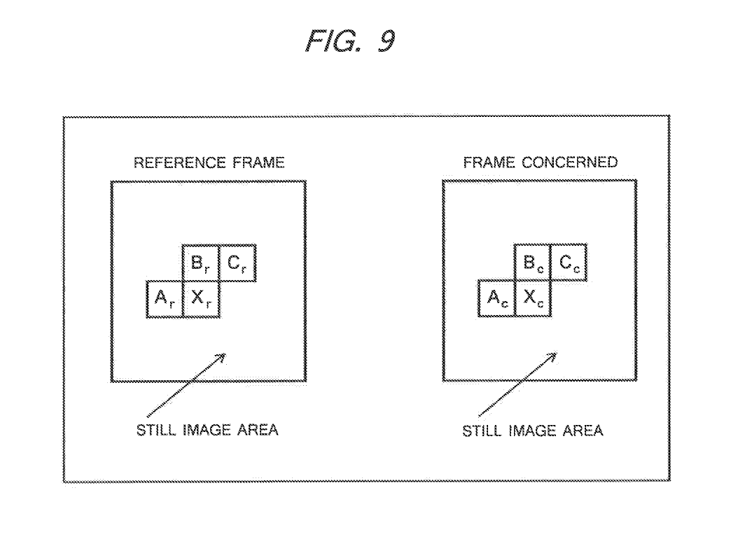

Furthermore, even when the block concerned, the corresponding block and the respective adjacent blocks exist in the still image areas with respect to both the reference frame and the frame concerned as in the case of an example of FIG. 9, the following formula (18) is satisfied.

MVX_{c}=MVXᵣ=0

MVA_{c}=MVAᵣ=0

MVB_{c}=MVBᵣ=MVC_{c}=MVCᵣ= (18)

Accordingly, the prediction motion vector information pmvᵣ in the corresponding block of the reference frame is represented by the following formula (19), and the differential motion vector information mvdᵣ which corresponds to the difference between the prediction motion vector information and the motion vector information in the corresponding block is represented by the following formula (20).

pmv_{c}=Median(MVA_{c},MVB_{c},MVC_{c})=Median(0,0,0)=0 (19)

mvd_{c}=MVX_{c}pmv_{c}=00=0 (20)

Furthermore, the prediction motion vector information pmv_{c} in the block concerned of the frame concerned is represented by the following formula (21), and the differential motion vector information mvd_{c} corresponding to the difference between the prediction motion vector information and the motion vector information in the block concerned is represented by the following formula (22)

pmv_{c}=Median(MVA_{c},MVB_{c},MVC_{c})=Median(0,0,0)=0 (21)

mvd_{c}=MVX_{c}pmv_{c}=00=0 (22)

As described above, in the example of FIG. 9, a high coding efficiency can be attained by even the mere median prediction. In the case of the example of FIG. 9, the secondary differential motion vector information mvdd is represented by the following formula (23)

mvdd=00=0 (23)

That is, even when the method of the present invention is applied in the case of the example of FIG. 9, the coding efficiency is not reduced.

According to the proposal described in Non-patent Document 1, the case classification processing is performed in such a case as the example of FIG. 8 and such a case as the example of FIG. 9, and different processing is executed on these cases. The execution of the case classification processing requires conditional branching and thus requires a huge amount of calculation.

On the other hand, according to the present invention, the case classification processing based on the conditional branching is not executed, and the coding efficiency of the motion vector information in such a case as the example of FIG. 8 can be enhanced without reducing the coding efficiency of the motion vector information in such a case as the example of FIG. 9. Furthermore, in the case of the proposal described in Non-patent Document 1, it is required to transmit flag information representing which processing is executed in accordance with the case classification processing described above. On the other hand, according to the present invention, since the case classification processing is not executed, it is not required to transmit such flag information, and thus the compression efficiency can be avoided from being reduced due to the transmission of the flag information.

The description will be made in more detail.

### [Example of Construction of Motion Prediction/Compensation Unit and Motion Vector Information Encoder]

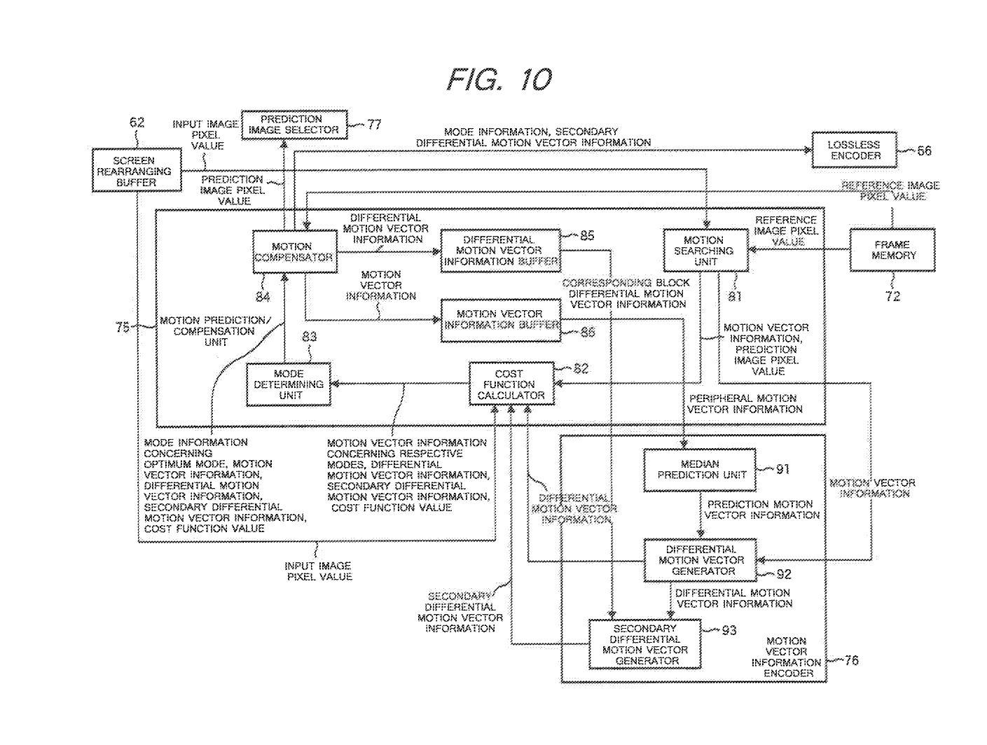

FIG. 10 is a block diagram depicting an example of the detailed construction of the motion prediction/compensation unit 75 and the motion vector information encoder 76. In FIG. 10, the switch 73 of FIG. 7 is omitted.

In the example of FIG. 10, the motion prediction/compensation unit 75 is constructed by a motion searching unit 81, a cost function calculator 82, a mode determining unit 83, a motion compensator 84, a differential motion vector information buffer 85 and a motion vector information buffer 86. The motion vector information encoder 76 is constructed by a median prediction unit 91, a differential motion vector generator 92 and a secondary differential motion vector generator 93.

An input image pixel value from the screen rearranging buffer 62 and a reference image pixel value from the frame memory 72 are input to the motion searching unit 81. The motion searching unit 81 executes the motion searching processing on all the inter prediction modes depicted in FIG. 2, and executes the compensation processing on the reference image by using the searched motion vector information to generate a prediction image. The motion searching unit 81 supplies the cost function calculator 82 with the motion vector information searched for each inter prediction mode and the generated prediction image pixel value. The motion searching unit 81 supplies the differential motion vector generator 92 with the motion vector information searched for each inter prediction mode.

The cost function calculator 82 is supplied with the input image pixel value from the screen rearranging buffer 62, the motion vector information of each inter prediction mode and the prediction image pixel value from the motion searching unit 81, the differential motion vector information from the differential motion vector generator 92 and the secondary differential motion vector information from the secondary differential motion vector generator 93.

The cost function calculator 82 calculates the cost function value corresponding to each inter prediction mode by using the supplied information. The secondary differential motion vector information is used as the motion vector information to be encoded in the cost function. The cost function calculator 82 supplies the mode determining unit 83 with the motion vector information of each inter prediction mode, the differential motion vector information, the secondary differential motion vector information and the cost function value.

The mode determining unit 83 determines by using the cost function value for each inter prediction mode which one of the respective inter prediction modes is optimally used. The inter prediction mode having the smallest cost function value is set as the optimum prediction mode. The mode determining unit 83 supplies a motion compensator 84 with the optimum prediction mode information, the motion vector information corresponding to the optimum prediction mode information, the differential motion vector information, the secondary differential motion vector information and the cost function value.

The motion compensator 84 compensates the reference image from the frame memory 72 by using the motion vector corresponding to the optimum prediction mode from the mode determining unit 83 to generate a prediction image of the optimum prediction mode. The motion compensator 84 outputs the prediction image of the optimum prediction mode and the cost function value to the prediction image selector 77.

When the prediction image of the optimum inter mode is selected by the prediction image selector 77, the signal representing that is supplied from the prediction image selector 77. In accordance with this, the motion compensator 84 supplies the optimum inter mode information and the secondary differential motion vector information of the mode concerned to the lossless encoder 66 to send these information to the decoding side. Furthermore, the motion compensator 84 stores the differential motion vector information into the differential motion vector information buffer 85, and stores the motion vector information into the motion vector information buffer 86.

When the prediction image of the optimum inter mode is not selected by the prediction image selector 77 (that is, when the intra prediction image is selected), 0 vector is stored as the differential motion vector information and the motion vector information in the differential motion vector information buffer 85 and the motion vector information buffer 86, respectively.

The differential motion vector information of each block of the optimum prediction mode is stored in the differential motion vector information buffer 85. The stored differential motion vector information is supplied as the corresponding block differential motion vector information to the secondary differential motion vector generator 93 to generate a secondary differential motion vector of the block at the same position in the next frame.

The motion vector information of each block of the optimum prediction mode is stored in the motion vector information buffer 86. The stored motion vector information is supplied as the peripheral motion vector information to the median prediction unit 91 to generate the prediction motion vector information of the next block.

The median prediction unit 91 generates the prediction motion vector information according to the median prediction of the foregoing formula (5) by using the motion vector information of the peripheral blocks spatially-adjacent to the current block which are supplied from the motion vector information buffer 86. The median prediction unit 91 supplies the generated prediction motion vector information to the differential motion vector generator 92.

The differential motion vector generator 92 generates the differential motion vector information according to the foregoing formula (6) by using the motion vector information from the motion searching unit 81 and the prediction motion vector information from the median prediction unit 91. The differential motion vector generator 92 supplies the generated differential motion vector information to the cost function calculator 82 and the secondary differential motion vector generator 93.

As in the formula (16) described above, the secondary differential motion vector generator 93 takes the difference between the differential motion vector information of the current block from the differential motion vector generator 92 and the differential motion vector information of the corresponding block of the current block from the differential motion vector information buffer 85. The secondary differential motion vector generator 93 supplies the cost function calculator 82 with the secondary differential motion vector information derived from the differential result.

### [Description of Coding Processing of Image Encoding Device]

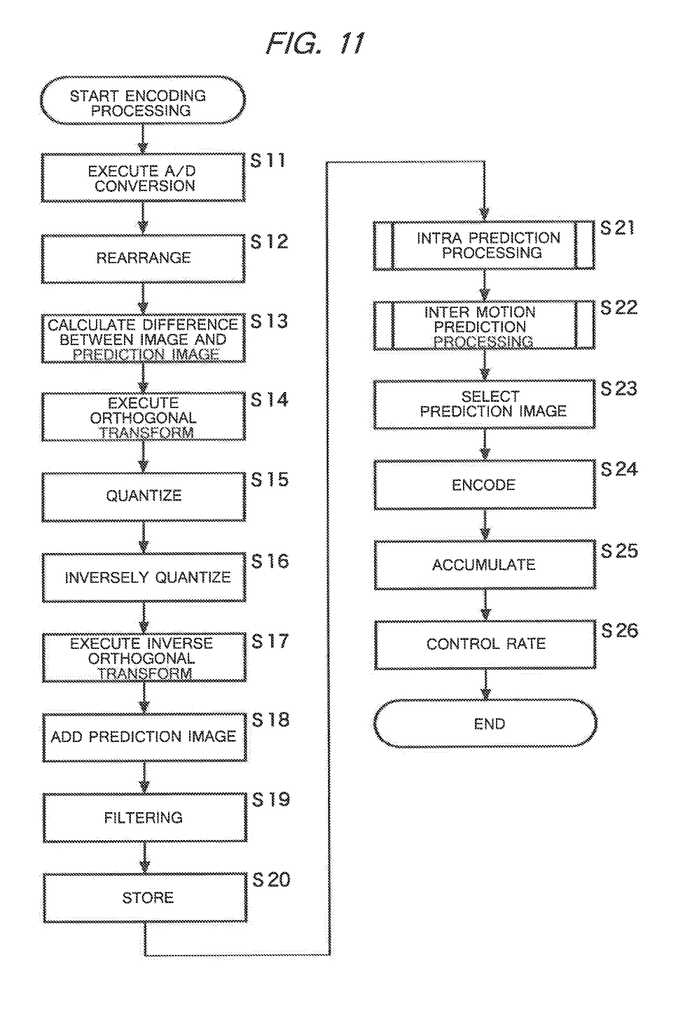

Next, the coding processing of the image encoding device 51 of FIG. 7 will be described with reference to the flowchart of FIG. 11.

In step S11, the A/D converter 61 A/D-converts input images. In step S12, the screen rearranging buffer 62 stores the images supplied from the A/D converter 61, and rearranges the images from the picture display order to the encoding order.

In step S13, the calculator 63 calculates the difference between the image rearranged in step S12 and the prediction image. The prediction image is supplied to the calculator 63 through the prediction image selector 77 from the motion prediction/compensation unit 75 when the inter prediction is executed and from the intra prediction unit 74 when the intra prediction is executed.

The differential data has a smaller data amount as compared with the original image data. Accordingly, the data amount can be compressed as compared with a case where the image is directly encoded.

In step S14, the orthogonal transformer 64 orthogonally transforms the differential information supplied from the calculator 63. Specifically, orthogonal transform such as discrete cosine transform or Karhunen-Loeve transform is executed, and a transform coefficient is output. In step S15, the quantizing unit 65 quantizes the transform coefficient. With respect to this quantization, the rate is controlled as described with reference to the processing of step S26 described later.

The differential information quantized as described above is locally decoded as follows. That is, in step S16, the inverse quantizing unit 68 inversely quantizes the transform coefficient quantized by the quantizing unit 65 based on the characteristic corresponding to the characteristic of the quantizing unit 65. In step S17, the inverse orthogonal transformer 69 inversely orthogonally transforms the transform coefficient inversely-quantized by the inverse quantizing unit 68 based on the characteristic corresponding to the characteristic of the orthogonal transformer 64.

In step S18, the calculator 70 adds the prediction image input through the prediction image selector 77 to the locally decoded differential information to generate a locally decoded image (the image corresponding to the input to the calculator 63). In step 319, the deblock filter 71 filters the image output from the calculator 70, thereby removing block distortion. In step S20, the frame memory 72 stores the filtered image. An image which is not subjected to filtering processing by the deblock filter 71 is also supplied from the calculator 70 to the frame memory 72, and stored in the frame memory 72.

When the processing target image supplied from the screen rearranging buffer 62 is an image of a block to be subjected to intra processing, a decoded image to be referred to is read from the frame memory 72, and supplied through the switch 73 to the intra prediction unit 74.

Based on these images, the intra prediction unit 74 executes the intra prediction on the pixels of the processing target block in all the intra prediction modes as candidates in step S21. Pixels which have not yet been subjected to deblock filtering by the deblock filter 71 are used as decoded pixels to be referred to.

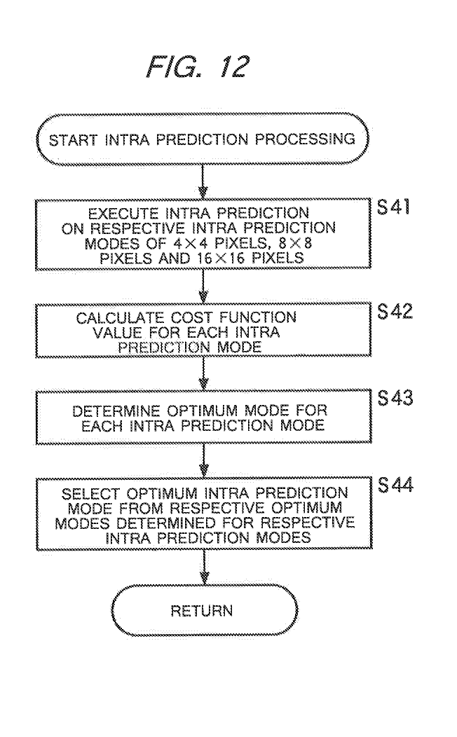

The details of the intra prediction processing in step S21 will be described later with reference to FIG. 12. The intra prediction is executed in all the intra prediction modes as candidates through this processing, and the cost function values for all the intra prediction modes as candidates are calculated. The optimum intra prediction mode is selected based on the calculated cost function values, and the prediction image generated according to the intra prediction of the optimum intra prediction mode and the cost function value thereof are supplied to the prediction image selector 77.

When the processing target image supplied from the screen rearranging buffer 62 is an image to be subjected to the inter processing, images to be referred to are read from the frame memory 72, and supplied through the switch 73 to the motion prediction/compensation unit 75. The motion prediction/compensation unit 75 executes the inter motion prediction processing based on these images in step S22.

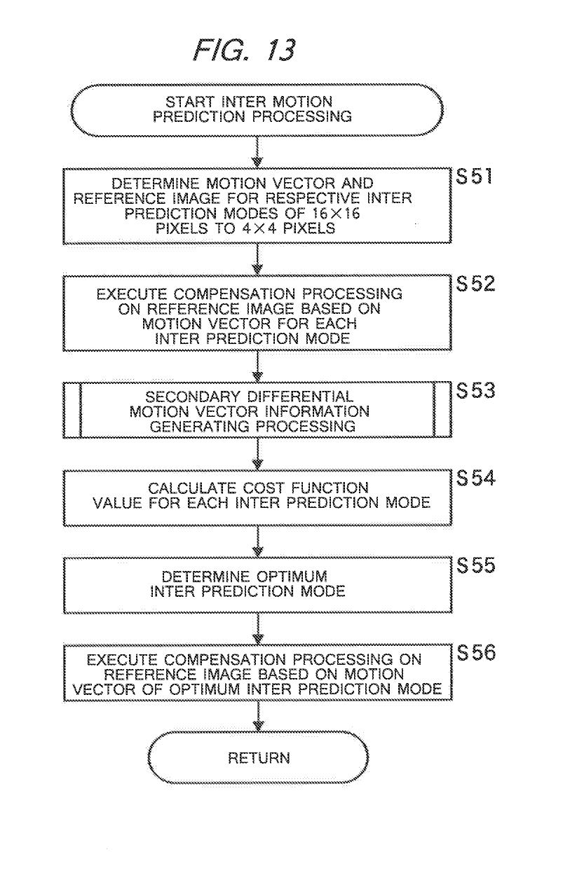

The details of the inter motion prediction processing in step S22 will be described later with reference to FIG. 13. Through this processing, the motion searching processing is executed in all the inter prediction modes as candidates, the prediction motion vector information, the differential motion vector information and the secondary differential motion vector information are successively generated, and the cost functions for all the inter prediction modes are calculated. Then, the optimum inter prediction mode is determined. The prediction image generated in the optimum inter prediction mode and the cost function value thereof are supplied to the prediction image selector 77.

In step S23, the prediction image selector 77 determines one of the optimum intra prediction mode and the optimum inter prediction mode as the optimum prediction mode based on each cost function value output by the intra prediction unit 74 and the motion prediction/compensation unit 75. The prediction image selector 77 selects the prediction image of the determined optimum prediction mode, and supplies the prediction image to the calculators 63 and 70. This prediction image is used for the calculation of steps S13 and S18 as described above.

The selection information of this prediction image is supplied to the intra prediction unit 74 or the motion prediction/compensation unit 75. When the prediction image of the optimum intra prediction mode is selected, the intra prediction unit 74 supplies the lossless encoder 66 with information representing the optimum intra prediction mode (that is, the intra prediction mode information).

When the prediction image of the optimum inter prediction mode is selected, the motion prediction/compensation unit 75 outputs, to the lossless encoder 66, the information representing the optimum inter prediction mode and further the information associated with the optimum inter prediction mode as occasion demands. The secondary differential motion vector information of each block, the reference frame information and the like may be provided as the information associated with the optimum inter prediction mode. At this time, the motion compensator 84 of the motion prediction/compensation unit 75 stores the differential motion vector information into the differential motion vector information buffer 85, and stores the motion vector information into the motion vector information buffer 86.

In step S24, the lossless encoder 66 encodes the quantized transform coefficient output by the quantizing unit 65. That is, the differential image is subjected to lossless coding such as variable-length coding, arithmetic coding or the like to be compressed. At this time, the intra prediction mode information from the intra prediction unit 74 which is input into the lossless encoder 66 in step S21 described above or the information associated with the optimum inter prediction mode from the motion prediction/compensation unit 75 in step S22 is also encoded, and added to the header information.

For example, the information representing the inter prediction mode is encoded every macro block. The secondary differential motion vector information and the reference frame information are encoded every target block.

The accumulation buffer 67 accumulates the differential image as the compressed image in step S25. The compressed images accumulated in the accumulation buffer 67 are arbitrarily read and transmitted to the decoding side through a transmission path.

In step S26, the rate controller 78 controls the rate of the quantization operation of the quantizing unit 65 based on the compressed images accumulated in the accumulation buffer 67 so that neither overflow nor underflow occurs.

### [Description of Intra Prediction Processing]

The intra prediction processing in step S21 of FIG. 11 will be described with reference to the flowchart of FIG. 12. In an example of FIG. 12, the description will be made in the case of a brightness signal.

In step S41, the intra prediction unit 74 executes the intra prediction on each of the intra prediction modes of 4×4 pixels, 8×8 pixels and 16×16 pixels.

Nine kinds of block-based prediction modes of 4×4 pixels and 8×8 pixels and four kinds of macro-block-based prediction modes of 16×16 pixels are provided as the intra prediction modes of brightness signals. Four kinds of block-based prediction modes of 8×8 pixels are provided as the intra prediction modes of color-difference signals. The intra prediction modes of the color-difference signals can be set independently of the intra prediction modes of the brightness signals. With respect to the intra prediction modes of 4×4 pixels and 8×8 pixels of the brightness signals, one intra prediction mode is defined for one block of the brightness signals of 4×4 pixels and 8×8 pixels. With respect to the intra prediction modes of 16×16 pixels of the brightness signals and the intra prediction modes of the color-difference signals, one prediction mode is defined for one macro block.

Specifically, the intra prediction unit 74 executes the intra prediction on pixels of a processing target block by referring to decoded images which are read from the frame memory 72 and supplied through the switch 73. This intra prediction processing is executed in each intra prediction mode, whereby a prediction image in each intra prediction mode is generated. Pixels which are not subjected to deblock filtering by the deblock filter 71 are used as the decoded pixels to be referred to.

In step S42, the intra prediction unit 74 calculates the cost function value for each of the intra prediction modes of 4×4 pixels, 8×8 pixels and 16×16 pixels. Here, the cost function adopted in the H. 264/AVC system is used as the cost function to calculate the cost function value as described below.

The H. 264/AVC system uses a method of selecting two mode determining methods of High Complexity Mode and Low Complexity Mode determined in JM, for example. In this method, the cost function value concerning prediction mode Mode is calculated in both the methods, and the prediction mode minimizing the cost function value is selected as the optimum mode for blocks from the block concerned to the macro block.

The cost function value in High Complexity Mode can be calculated according to the following formula (24)

Cost(ModeεΩ)=D+λ×R (24)

In the formula (24), Ω represents a universal set of candidate modes to encode the blocks from the block concerned to the macro block. Furthermore, D represents the differential energy between the decoded image and the input image when the encoding is performed in the prediction mode Mode concerned. Furthermore, λ represents a Lagrange undetermined multiplier given as a function of quantization parameters. R represents a total coding amount containing an orthogonal transform coefficient when encoding is performed in the mode Mode concerned.

That is, since the above parameters C and R are calculated to perform the encoding in High Complexity Mode, it is necessary to perform temporal encoding processing once in all the candidate mode Modes, and thus a higher calculation amount is required.

On the other hand, the cost function value in Low Complexity Mode can be calculated according to the following formula (25).

Cost(ModeδΩ)=D+QP2Quant(QP)×HeaderBit (25)

In the formula (25), C represents the differential energy between the prediction image and the input image unlike the case of High Complexity Mode. QP2Quant (QP) is given as the function of quantization parameter QP. Furthermore, HeaderBit represents a coding amount concerning information belonging to Header such as motion vector and mode, not containing the orthogonal transform coefficient.

That is, in Low Complexity Mode, it is required to perform the prediction processing with respect to each candidate mode Mode. However, it is not required for the decoded image, and thus it is unnecessary to perform the encoding processing. therefore, the prediction processing can be performed with a lower calculation amount than High Complexity Mode.

In step S43, the intra prediction unit 74 determines the optimum mode for each of the intra prediction modes of 4×4 pixels, 8×8 pixels and 16×16 pixels. That is, as described above, in the case of the intra 4×4 prediction mode and the intra 8×8 prediction mode, there are nine kinds of prediction modes, and in the case of the intra 16×16 prediction mode, there are four kinds of prediction modes. Accordingly, the intra prediction unit 74 determines the optimum intra 4×4 prediction mode, the optimum intra 8×8 prediction mode and the optimum intra 16×16 prediction mode from the above prediction modes based on the cost function values calculated in step S42.

In step 44, the intra prediction unit 74 selects the optimum intra prediction mode from the optimum modes determined for the respective intra prediction modes of 4×4 pixels, 8×8 pixels and 16×16 pixels based on the cost function values calculated in step 342. That is, the mode in which the cost function value is minimum is selected as the optimum intra prediction mode from the optimum modes determined for 4×4 pixels, 8×8 pixels and 16×16 pixels. The intra prediction unit 74 supplies the prediction image selector 77 with the prediction image generated in the optimum intra prediction mode and the cost function value thereof.

### [Description of Inter Motion Prediction Processing]

Next, the inter motion prediction processing of step S22 of FIG. 11 will be described with reference to the flowchart of FIG. 13.

In step S51, the motion searching unit 81 determines the motion vector and the reference image for each of the eight kinds of inter prediction modes of 16×16 pixels to 4×4 pixels of FIG. 2 described above.

In step S52, the motion searching unit 81 executes the compensation processing on the reference image based on the determined motion vector with respect to each inter prediction mode to generate a prediction image. The motion searching unit 81 supplies the cost function calculator 82 with the searched motion vector information (MVX_{c}) for each inter prediction mode and the generated prediction image pixel value. The motion searching unit 81 supplies the differential motion vector generator 92 with the motion vector information (MVX_{c}) searched for each inter prediction mode.

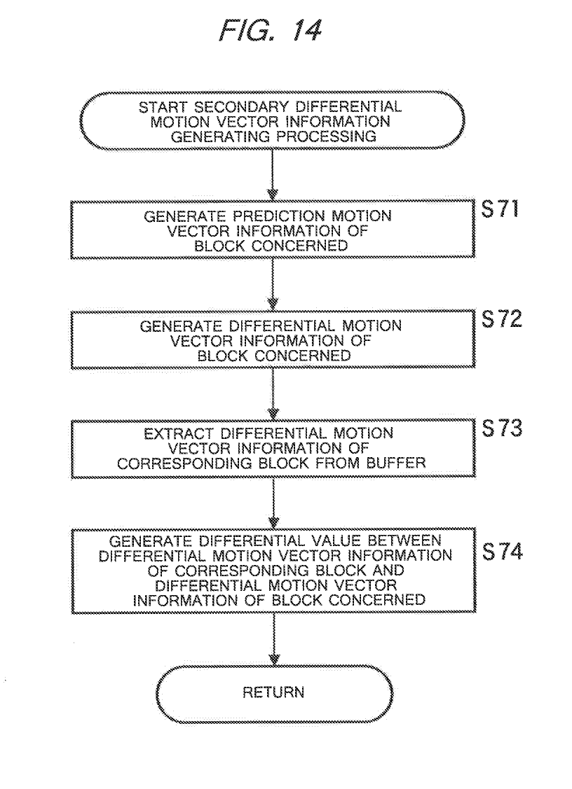

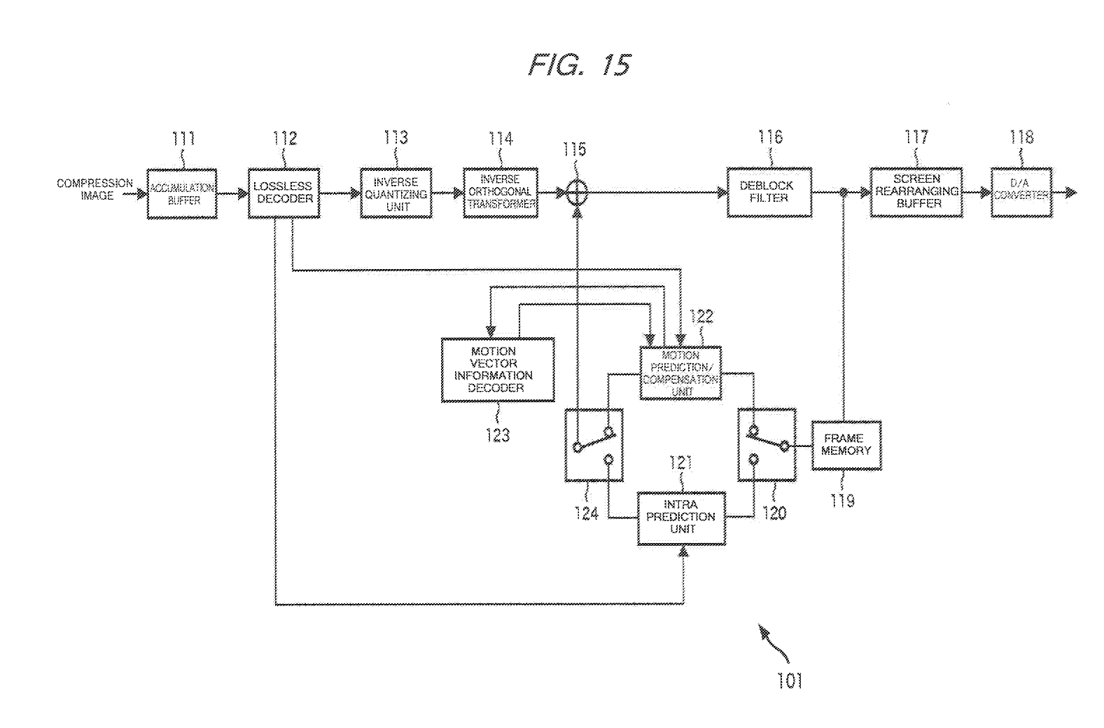

In step S53, the motion vector information encoder 76 executes the processing of generating the secondary differential motion vector information. The details of the processing of generating the secondary differential motion vector information will be described later with reference to FIG. 14.

Through the processing of step S53, the prediction motion vector information (pmv_{c}) of each block of each inter prediction mode is generated, the differential motion vector information (mvd_{c}) is generated, and further the secondary differential motion vector information (mvdd) is generated. The generated differential motion vector information (mvd_{c}) and secondary differential motion vector information (mvdd) are supplied to the cost function calculator 82.

The cost function calculator 82 is supplied with the input image pixel value from the screen rearranging buffer 62, the motion vector information (MVX_{c}) and the prediction image pixel value of each inter prediction mode from the motion searching unit 81, the differential motion vector information (mvd_{c}) from the differential motion vector generator 92 and the secondary differential motion vector information (mvdd) from the secondary differential motion vector generator 93. In step S54, the cost function calculator 82 calculates the cost function value for each inter prediction mode by using the supplied information according to the foregoing formula (24) or (25). At this time, the secondary differential motion vector information (mvdd) is used as the coding target motion vector information. The cost function calculator 82 supplies the mode determining unit 83 with the motion vector information (MVX_{c}), the differential motion vector information (mvd_{c}), the secondary differential motion vector information (mvdd) and the cost function value with respect to each inter prediction mode.

In step S55, the mode determining unit 83 determines the optimum inter prediction mode. That is, the mode determining unit 83 compares the cost function values of all inter prediction modes as candidates, and the inter prediction mode providing the minimum cost function value is determined as the optimum inter prediction mode. The mode determining unit 83 supplies the motion compensator 84 with the optimum prediction mode information, and the motion vector information (MVX_{c}), the differential motion vector information (mvd), the secondary differential motion vector information (mvdd) and the cost function value corresponding to the optimum prediction mode information.

In step S56, the motion compensator 84 executes the compensation processing on the reference image from the frame memory 72 based on the motion vector of the optimum inter prediction mode to generate a prediction image. The motion compensator 84 outputs the prediction image and the cost function value of the optimum prediction mode to the prediction image selector 77.

### [Description of Secondary Differential Motion Vector Information Generating Processing]

Next, the secondary differential motion vector information generating processing of step S53 of FIG. 13 will be described with reference to the flowchart of FIG. 14.

In step S71, the median prediction unit 91 generates the prediction motion vector information (pmv_{c}) according to the median prediction of the foregoing formula (5) by using the motion vector information of the peripheral blocks spatially adjacent to the block concerned which is supplied from the motion vector information buffer 86. The median prediction unit 91 supplies the generated prediction motion vector information (pmv_{c}) to the differential motion vector generator 92.

In step S72, the differential motion vector generator 92 generates the differential motion vector information (mvd_{c}) of the block concerned according to the foregoing formula (6) by using he motion vector information from the motion searching unit 81 and the prediction motion vector information from the median prediction unit 91. The differential motion vector generator 92 supplies the generated differential motion vector information (mvd_{c}) to the cost function calculator 82 and the secondary differential motion vector generator 93.

In step S73, the secondary differential motion vector generator 93 extracts the differential motion vector information (mvdᵣ) of the corresponding block to the block concerned from the differential motion vector information buffer 85. When the corresponding block is an intra macro block, the differential motion vector information mvdᵣ of the corresponding block is set to zero.

In step S74, according to the formula (16), the secondary differential motion vector generator 93 generates the secondary differential motion vector information (mvdd) as the difference value between the differential motion vector information (mvdᵣ) of the corresponding block and the differential motion vector information (mvd_{c}) of the block concerned. The secondary differential motion vector generator 93 supplies the generated secondary differential motion vector information (mvdd) to the cost function calculator 82.

As described above, in the image encoding device 51, the secondary differential motion vector information corresponding to the difference between the differential motion vector information of the block concerned and the differential motion vector information of the corresponding block is encoded as the motion vector information of the block concerned to be transmitted to the decoding side. That is, not only the spatial correlation, but also spatio-temporal correlation is used.

Accordingly, increase of the processing amount can be suppressed, and also the coding efficiency of the motion vector information to be transmitted to the decoding side can be enhanced when the prediction motion vector information is generated.

The encoded compressed image is transmitted through a predetermined transmission path and decoded by the image decoding device.

### [Example of Construction of Image Decoding Device]

FIG. 15 is a diagram depicting the construction of an embodiment of the image decoding device as the image processing apparatus to which the present invention is applied.

An image decoding device 101 is constructed by an accumulation buffer 111, a lossless decoder 112, an inverse quantizing unit 113, an inverse orthogonal transformer 114, a calculator 115, a deblock filter 116, a screen rearranging buffer 117, a D/A converter 118, a frame memory 119, a switch 120, an intra prediction unit 121, a motion prediction/compensation unit 122, a motion vector information decoder 123 and a switch 124.

The accumulation buffer 111 accumulates the transmitted compressed image. According to the system corresponding to the encoding system of the lossless encoder 66, the lossless decoder 112 decodes the information that is supplied from the accumulation buffer 111 and encoded by the lossless encoder 66 of FIG. 7. The inverse quantizing unit 113 inversely quantizes the image decoded by the lossless decoder 112 according to the system corresponding to the quantizing system of the quantizing unit 65 of FIG. 7. The inverse orthogonal transformer 114 inversely orthogonally transforms the output of the inverse quantizing unit 113 according to the system corresponding to the orthogonal transform system of the orthogonal transformer 64 of FIG. 7.

The inversely orthogonally transformed output is added to the prediction image supplied from the switch 124 by the calculator 115 and decoded. After the deblock filter 116 removes the block distortion of the decoded image, the deblock filter 116 supplies and accumulates the image into the frame memory 119 and also outputs the image to the screen rearranging buffer 117.

The screen rearranging buffer 117 rearranges the images. That is, the order of the frames rearranged for the encoding order by the screen rearranging buffer 62 of FIG. 7 is rearranged to the original display order. The D/A converter 118 D/A-converts the images supplied from the screen rearranging buffer 117, and outputs the images to a display (not depicted) to display the images.

The switch 120 reads the images to be subjected to the inter processing and images to be referred to from the frame memory 119, and outputs the images to the motion prediction/compensation unit 122. In addition, the switch 120 reads the images used for the intra prediction from the frame memory 119 and supplies the images to the intra prediction unit 121.

The information representing the intra prediction mode obtained by decoding the header information is supplied from the lossless decoder 112 to the intra prediction unit 121. The intra prediction unit 121 generates the prediction image based on this information, and outputs the generated prediction image to the switch 124.

The inter prediction mode information, the secondary differential motion vector information, the reference frame information and the like out of the information obtained by decoding the header information are supplied from the lossless decoder 112 to the motion prediction/compensation unit 122. The inter prediction mode information is transmitted every macro block. The secondary differential motion vector information and the reference frame information are transmitted every block.

The motion prediction/compensation unit 122 supplies the secondary differential motion vector information of the current block supplied from the lossless decoder 112 to the motion vector information decoder 123, and obtains the differential motion vector information and the motion vector information of the current block generated by the motion vector information decoder 123 in accordance with the supplied secondary differential motion vector information. The motion prediction/compensation unit 122 executes the compensation processing on the reference image from the frame memory 119 by using the motion vector information from the motion vector information decoder 123, and generates the pixel values of the prediction image for the current block in the prediction mode represented by the inter prediction mode information supplied from the lossless decoder 112. The motion prediction/compensation unit 122 accumulates the differential motion vector information from the motion vector information decoder 123 to generate prediction motion vector information of the next current block.

When supplied with the secondary differential motion vector information of the current block from the motion prediction/compensation unit 122, the motion vector information decoder 123 obtains the motion vector information of the peripheral blocks to the current block and the differential motion vector information of the corresponding block to the current block from the motion prediction/compensation unit 122.

The motion vector information decoder 123 generates the prediction motion vector information by using the obtained motion vector information of the peripheral blocks. The motion vector information decoder 123 generates the differential motion vector information of the current block by using the secondary differential motion vector information and the differential motion vector information of the corresponding block. Furthermore, the motion vector information decoder 123 generates the motion vector information of the current block by using the generated differential motion vector information and the generated prediction motion vector information. The generated motion vector information and differential motion vector information of the current block are stored in the motion prediction/compensation unit 122.

The switch 124 selects the prediction image generated by the motion prediction/compensation unit 122 or the intra prediction unit 121, and supplies the prediction image to the calculator 115.

It is necessary in the motion prediction/compensation unit 75 of FIG. 7 to perform the generation of the prediction image and the calculation of the cost function value med for all the candidate modes for mode determination. On the other hand, in the motion prediction/compensation unit 122 of FIG. 15, the mode information and the secondary differential motion vector information (mvdd) concerning the block concerned are received from the header of the compressed image, and only the motion compensation processing using these information is executed.

That is, in the image decoding device 101 of FIG. 15, the secondary differential motion vector information is received, and the prediction motion vector information (pmv_{c}) is generated from the motion vector information of the peripheral blocks of the current block according to the median prediction of the foregoing formula (5). Furthermore, the differential motion vector information (mvdᵣ) in the corresponding block of the current block is read from the buffer provided to the motion prediction/compensation unit 122.

Accordingly, the motion vector information my in the current block is calculated according to the following formula (26).

mv=mvdd+pmv_{c}+mvdᵣ (26)

In the image decoding device 101, the motion compensation is executed by using the thus-calculated motion vector information.

### [Example of Construction of Motion Prediction/compensation Unit and Motion Vector Information Decoder]

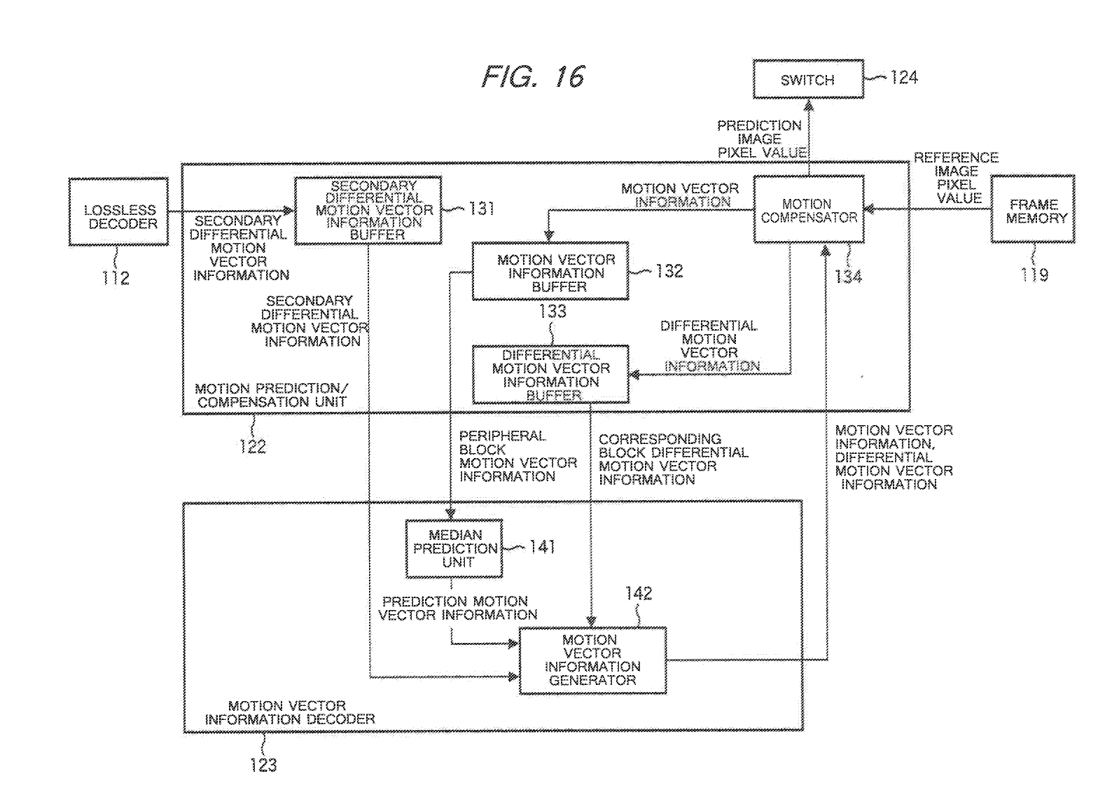

FIG. 16 is a block diagram depicting an example of the detailed construction of the motion prediction/compensation unit 122 and the motion vector information decoder 123. In FIG. 16, the switch 120 of FIG. 15 is omitted.

In the example of FIG. 16, the motion prediction/compensation unit 122 is constructed by a secondary differential motion vector information buffer 131, a motion vector information buffer 132, a differential motion vector information buffer 133 and a motion compensator 134. Furthermore, the motion vector information decoder 123 is constructed by a median prediction unit 141 and a motion vector information generator 142.

The secondary differential motion vector information buffer 131 is supplied with the secondary differential motion vector information of each block from the lossless decoder 112. The secondary differential motion vector information buffer 131 accumulates the supplied secondary differential motion vector information and supplies it to the motion vector information generator 142

The motion vector information buffer 132 stores the motion vector information of each block from the motion compensator 134 as the peripheral motion vector information to generate the prediction motion vector information of the next block. The differential motion vector information buffer 133 stores the differential motion vector information of each block from the motion compensator 134 as the differential motion vector information of the corresponding block to generate the motion vector information of each block of the next frame.

The motion compensator 134 executes the compensation processing on the reference image pixel values from the frame memory 119 by using the motion vector information of the current block from the motion vector information generator 142 to generate a prediction image. The motion compensator 134 supplies the prediction image pixel values to the switch 124, and also stores the motion vector information of the current block into the motion vector information buffer 132. The motion compensator 134 stores the differential motion vector information of the current block into the differential motion vector information buffer 133.

The median prediction unit 141 obtains the motion vector information of the peripheral blocks to the current block from the motion vector information buffer 132. The median prediction unit 141 generates the prediction motion vector information of the current block according to the median prediction of the foregoing formula (5) by using the obtained motion vector information of the peripheral blocks, supplies the generated prediction motion vector information to the motion vector information generator 142.

When supplied with the secondary differential motion vector information of the current block from the secondary differential motion vector information buffer 131, the motion vector information generator 142 reads the differential motion vector information in the corresponding block of the current block from the differential motion vector information buffer 133. Furthermore, the motion vector information generator 142 is also supplied with the prediction motion vector information of the current block from the median prediction unit 141.

The motion vector information generator 142 generates the motion vector information according to the foregoing formula (26). Furthermore, the motion vector information generator 142 generates the differential motion vector information of the current block by adding the secondary differential motion vector information with the differential motion vector information of the corresponding block, that is, according to the following formula (27). The generated motion vector information and differential motion vector information of the current block are supplied to the motion compensator 134.

mvd_{c}=mvdd+mvdᵣ (27)

### [Description of Decoding Processing of Image Decoding Device]

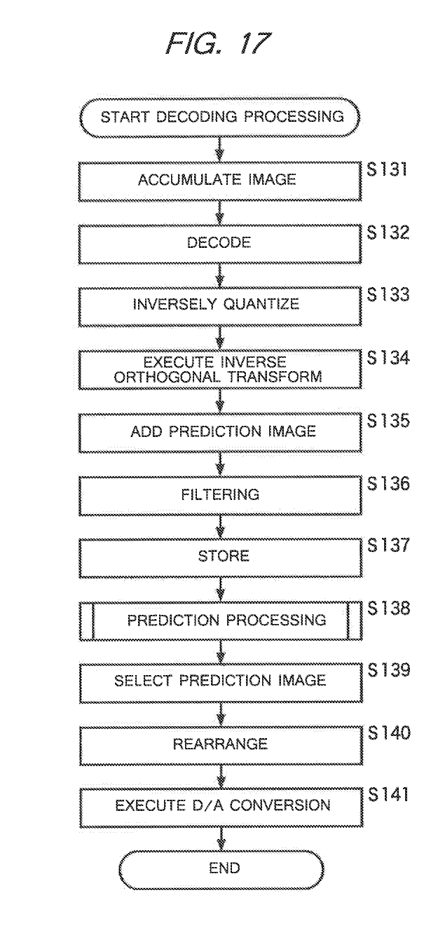

Next, the decoding processing executed by the image decoding device 101 will be described with reference to the flowchart of FIG. 17.

In step S131, the accumulation buffer 11 accumulates the transmitted image. In step S132, the lossless decoder 112 decodes the compressed image supplied from the accumulation buffer 111. That is, the I pictures, the P pictures and the B pictures encoded by the lossless encoder 66 of FIG. 7 are decoded.

At this time, the secondary differential motion vector information, the reference frame information, the prediction mode information (the information representing the intra prediction mode or the inter prediction mode) and the like are also decoded.

That is, when the prediction mode information is the intra prediction mode information, the prediction mode information is supplied to the intra prediction unit 121. When the prediction mode information is the inter prediction mode information, the secondary differential motion vector information and the reference frame information corresponding to the prediction mode information are supplied to the motion prediction/compensation unit 122.

In step S133, the inverse quantizing unit 113 inversely quantizes the transform coefficient decoded by the lossless decoder 112 according to the characteristic corresponding to the characteristic of the quantizing unit 65 of FIG. 7. In step S134, the inverse orthogonal transformer 114 inversely orthogonally transforms the transform coefficient inversely quantized by the inverse quantizing unit 113 according to the characteristic corresponding to the characteristic of the orthogonal transformer 64 of FIG. 7, whereby the differential information corresponding to the input of the orthogonal transformer 64 (the output of the calculator 63) of FIG. 7 is decoded.

In step S135, the calculator 115 adds the differential information with the prediction image that is selected by the processing of step S139 described later and input through the switch 124, whereby the original image is decoded. In step S136, the deblock filter 116 filters the image output from the calculator 115, whereby the block distortion is removed. In step S137, the frame memory 119 stores the filtered image.

In step S138, the intra prediction unit 121 or the motion prediction/compensation unit 122 executes the prediction processing on the image in accordance with the prediction mode information supplied from the lossless decoder 112.

That is, when the intra prediction mode information is supplied from the lossless decoder 112, the intra prediction unit 121 executes the intra prediction processing of the intra prediction mode. When the inter prediction mode information is supplied form the lossless decoder 112, the motion prediction/compensation unit 122 executes the motion prediction/compensation processing of the inter prediction mode. At this time, the differential motion vector information of the current block is generated from the secondary differential motion vector information from the lossless decoder 112 and the differential motion vector information of the corresponding block. Furthermore, the motion vector information of the current block is generated from the generated differential motion vector information of the current block and the prediction motion vector information generated from the motion vector information of the peripheral blocks. The generated motion vector information is used, and the compensation processing is executed on the reference image, thereby generating the prediction image of the inter prediction mode.

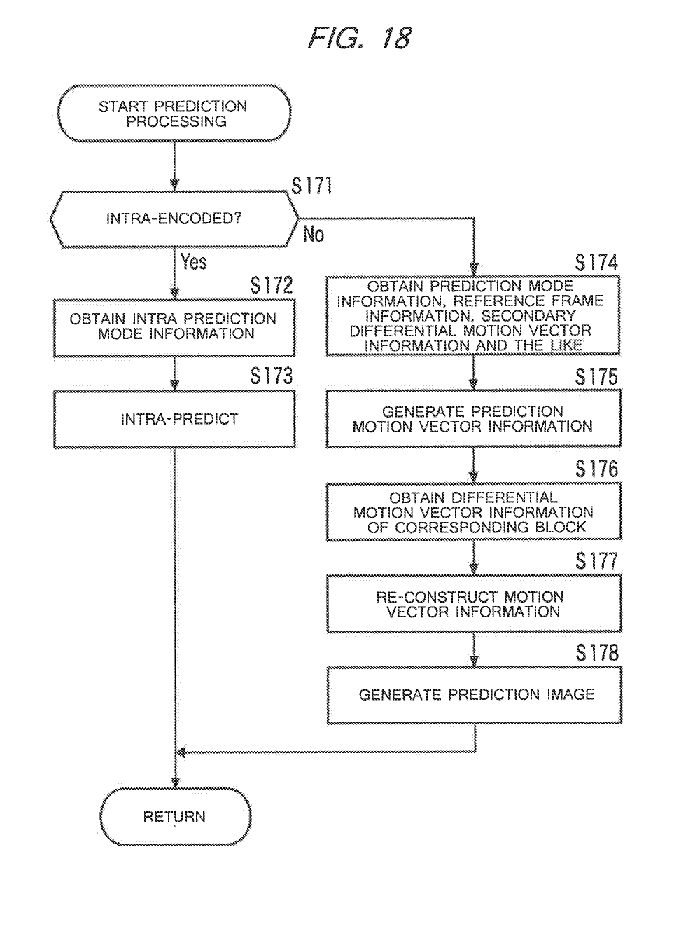

The details of the prediction processing in step S138 will be described later with reference to FIG. 18, and the prediction image generated by the intra prediction unit 121 or the prediction image generated by the motion prediction/compensation unit 122 is supplied to the switch 124.

In step S139, the switch 124 selects the prediction image. That is, the prediction image generated by the intra prediction unit 121 or the prediction image generated by the motion prediction/compensation unit 122 is supplied. Accordingly, the supplied prediction image is selected and supplied to the calculator 115, and added with the output of the inverse orthogonal transformer 114 in step S135 as described above.

In step S140, the screen rearranging buffer 117 performs the rearrangement. That is, the order of the frames rearranged for encoding by the screen rearranging buffer 62 of the image encoding device 51 is rearranged to the original display order.

In step S141, the D/A converter 118 D/A-converts the image from the screen rearranging buffer 117. This image is output to a display (not depicted) and the image is displayed on the display.

### [Description of Prediction Processing of Image Decoding Device]

Next, the prediction processing of step S138 of FIG. 17 will be described with reference to the flowchart of FIG. 18.

In step S171, the intra prediction unit 121 determines weather the current block has been subjected to intra coding or not. When the intra prediction mode information is supplied from the lossless decoder 112 to the intra prediction unit 121, the intra prediction unit 121 determines in step S171 that the current block is subjected to the intra coding, and the processing goes to step S172.

In step S172, the intra prediction unit 121 obtains the intra prediction information, and executes the intra prediction in step S173.

That is, when the processing target image is an image to be subjected to the intra processing, a necessary image is read from the frame memory 119, and supplied to the intra prediction unit 121 through the switch 120. In step S173, the intra prediction unit 121 executes the intra prediction according to the intra prediction mode information obtained in step S172 to generate a prediction image. The generated prediction image is output to the switch 124.

On the other hand, when it is determined in step S171 that the current block has not yet been to the intra coding, the processing goes to step S174.

when the processing target image is an image to be subjected to the inter processing, the inter prediction mode information of each macro block, and the reference frame information and the secondary differential motion vector information of each block are supplied from the lossless decoder 112 to the motion prediction/compensation unit 122.

In step S174, the motion prediction/compensation unit 122 obtains the inter prediction mode information, the reference frame information, the secondary differential motion vector information and the like. The obtained secondary differential motion vector information is accumulated in the secondary differential motion vector information buffer 131, and supplied to the motion vector information generator 142. The inter prediction mode information and the reference frame information are supplied to the motion compensator 134 although they are not depicted in the example of FIG. 16.

In step S175, the median prediction unit 141 generates the prediction motion vector information of the current block. That is, the median prediction unit 141 obtains, from the motion vector information buffer 132, the motion vector information of the peripheral blocks to the current block. The median prediction unit 141 generates prediction motion vector information of the current block according to the median prediction of the foregoing formula (5) by using the obtained motion vector information of the peripheral blocks, and supplies the generated prediction motion vector information to the motion vector information generator 142.

When the secondary differential motion vector information of the current block is supplied from the secondary differential motion vector information buffer 131, the motion vector information generator 142 obtains the differential motion vector information in the corresponding block of the current block from the differential motion vector information buffer 133 in step S176.

In step S177, the motion vector information generator 142 reconstructs the motion vector information of the current block according to the foregoing formula (26). That is, the motion vector information generator 142 adds the secondary differential motion vector information with the differential motion vector information of the corresponding block and the prediction motion vector information of the current block to generate motion vector information of the current block. Furthermore, according to the formula (27) described above, the motion vector information generator 142 generates differential motion vector information of the current block. The generated motion vector information and differential motion vector information of the current block are supplied to the motion compensator 134.

In step S178, the motion compensator 134 executes the compensation processing on the reference image pixel values from the frame memory 119 by using the motion vector information of the current block from the motion vector information generator 142 to generate a prediction image. Then, the motion compensator 134 supplies the prediction image pixel values to the switch 124, and stores the motion vector information of the current block into the motion vector information buffer 132. The motion compensator 134 stores the differential motion vector information of the current block into the differential motion vector information buffer 133.

As described above, the image encoding device 51 encodes and transmits the secondary differential motion vector information, and the image decoding device 101 receives the encoded secondary differential motion vector information, generates the motion vector information and executes the motion compensation processing. That is, in this invention, the correlation of the differential motion vector information between the current frame and the reference frame is used.

For example, in a case where the differential motion vector information based on the normal median prediction is encoded, the boundary between a still image area and a moving picture area is a weak point when the bit rate is low, and this weak point can be overcome.

As described above, when the prediction motion vector information is generated, the increase of the processing amount can be suppressed, and the coding efficiency can be enhanced.

A method of encoding the differential vector information based on the normal median prediction which is generated according to the foregoing formula (6) and a method of encoding the secondary differential motion vector information according to the present invention may be adaptively selected and used every motion prediction block. A method of calculating and comparing cost function values or the like may be used as the selection method in this case. In this case, flag information representing which one of the former and latter methods is used to perform encoding is added to the header of the compressed image every block and transmitted to the decoding side. Any information may be used as the flag information insofar as it can identify which one of the methods is used for encoding. At the decoding side, the flag information representing that the encoding is performed by the former method is referred to, and the motion vector information is generated by using the transmitted differential motion vector information based on the normal median prediction and the generated prediction motion vector information.

Furthermore, the motion vector encoding method according to the present invention can be performed with a lower calculation processing amount than the proposal of Non-patent Document 1 by the amount corresponding to non-execution of the conditional branching. However, a higher calculation amount is required than the median prediction processing defined in the H. 264/AVC system because the differential motion vector information is stored in the memory or the like and, referred to. Therefore, in accordance with a profile, the method of the present invention may be applied to only a profile which is attained with a higher calculation processing amount as in the case of High Profile in the H. 264/AVC. That is, profile_idc in the sequence parameter set in the coding parameters is referred to, and it is determined based on profile_idc whether the method of the present invention is applied or not.

In the foregoing description, the time correlation is used after the spatial correlation in the motion vector information is used. This is because the median prediction is used in H. 264/AVC. However, in the examples of FIGS. 8 and 9, encoding processing and decoding processing using spatio-temporal correlation of motion vector information in which the spatial correlation is used after time correlation is used may be performed.

With respect to the processing at the encoding side, diff_mvA, diff_mvB, diff_mvC and diff_mvX are first calculated as a first step according to the following formula (28).

diff_{—}mvA=(mvA_{c},mvAᵣ)

diff_{—}mvB−(mvB_{c},mvBᵣ)

diff_{—}mvC=(mvC_{c},mvCᵣ)

diff_{—}mvX=(mvX_{c},mvXᵣ) (28)

As a second step, diff_pmv is calculated according to the following formula (29)

diff_{—}pmv=Median(diff_{—}mvA,diff_{—}mvB,diff_{—}mvC) (29)

As a third step, the motion vector information mvdd to be encoded is calculated according to the following formula (30) The calculated mvdd is subjected to lossless encoding and transmitted.

mvdd=diff_{—}mvXdiff_{—}pmv (30)

With respect to the processing at the decoding side, as a first step, mvdd is extracted from the compressed image by the lossless decoding processing. Subsequently, as a second step, diff_pmv is generated as in the case of the encoding side. As a third step, the motion vector irformation mvXᵣ in the corresponding (co-located) block is extracted from the motion vector buffer.

As a result, the motion vector information mvXc for the current block is calculated according to the following formula (31).

mvX_{c}=mvdd+mvXᵣ+diff_{—}pmv (31)

In the foregoing description, the size of the macro block is equal to 16×16 pixels. However, the present invention may be applied to an expanded macro block size.

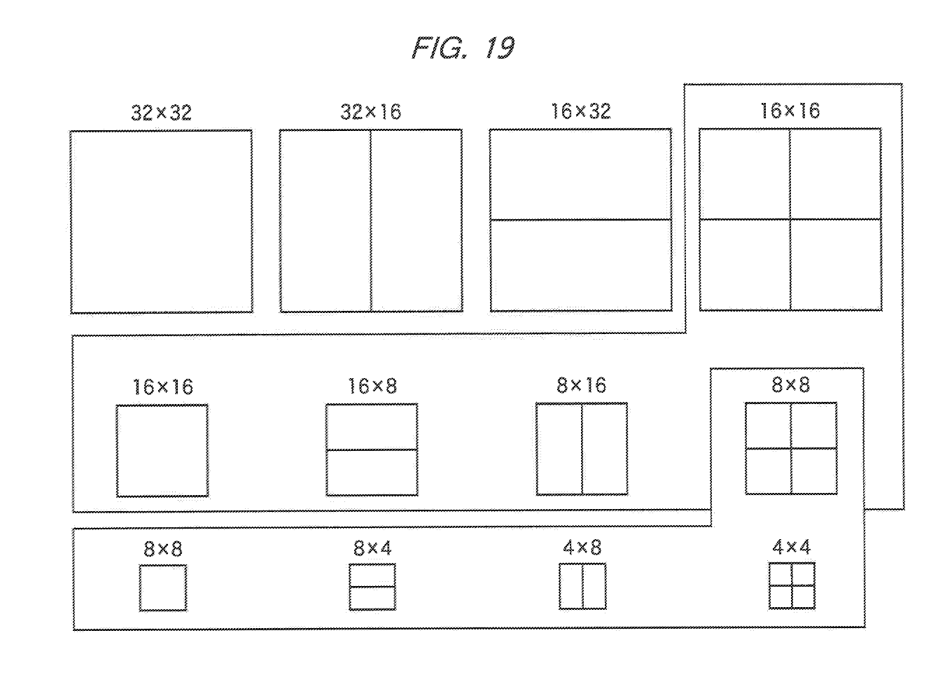

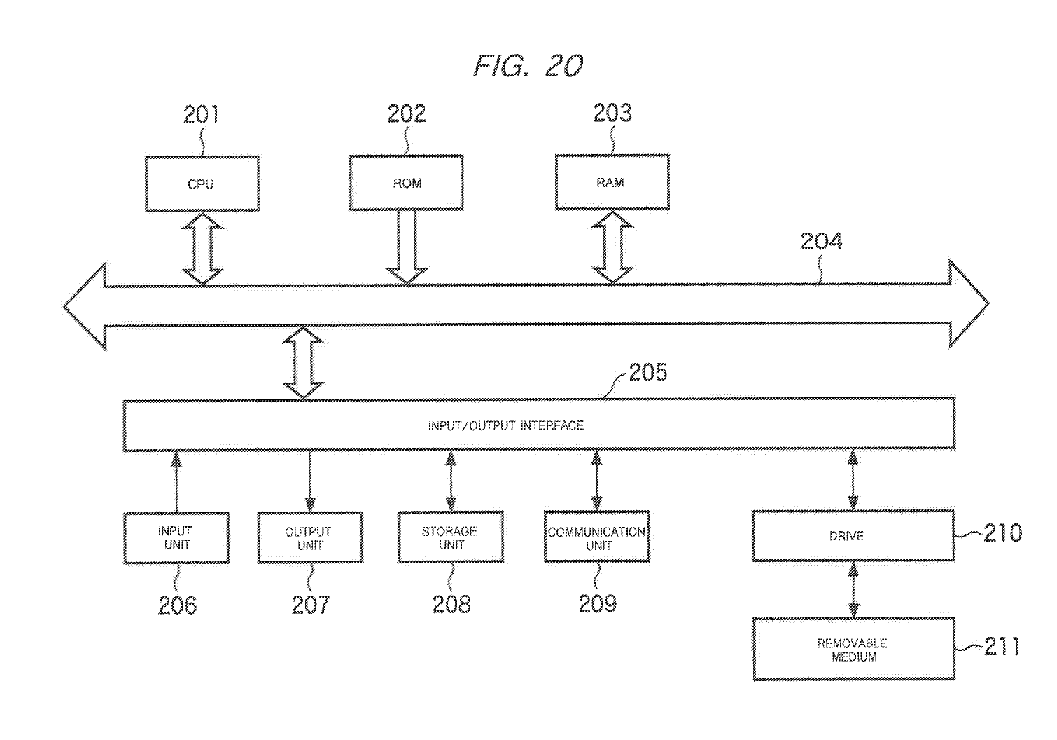

FIG. 19 is a diagram depicting an example of the expanded macro block size.

An upper stage of FIG. 19 successively depicts, from the left side, macro blocks constructed by 32×32 pixels that are divided into blocks (partitions) of 32×32 pixels, 32×16 pixels, 16×32 pixels and 16×16 pixels. A middle stage of FIG. 19 successively depicts, from the left side, blocks constructed by 16×16 pixels that are divided into blocks of 16×16 pixels, 16×8 pixels, 8×16 pixels and 8×8 pixels. Furthermore, a lower stage of FIG. 19 successively depicts, from the left side, blocks of 8×8 pixels that are divided into blocks of 8×8 pixels, 8×4 pixels, 4×8 pixels and 4×4 pixels.

That is, the processing for the blocks of 32×32 pixels, 32×16 pixels, 16×32 pixels and 16×16 pixels depicted at the upper stage of FIG. 19 may be applied to the macro blocks of 32×32 pixels.

The processing for the blocks of 16×16 piles, 16×8 pixels, 8×16 pixels and 8×8 pixels depicted at the middle stage may be applied to the block of 16×16 pixels depicted at the right side of the upper stage as in the case of the H. 264/AVC system.

Furthermore, the processing for the blocks of 8×8 pixels, 8×4 pixels, 4×8 pixels and 4×4 pixels depicted at the lower stage may be applied to the block of 8×8 pixels depicted at the right side of the middle stage as in the case of the −1H. 264/AVC system.

By adopting such a hierarchical structure, in the expanded macro block size, larger blocks are defined as super sets with keeping compatibility with the H. 264/AVC system with respect to the blocks of 16×16 pixels or less.

The present invention may be applied to the expanded macro block size proposed as described above.

In the foregoing description, the spatial prediction motion vector information (Spatial Predictor) based on the median prediction is used as the prediction motion vector information. The temporal prediction motion vector information (Temporal Predictor) and the spatio-temporal prediction motion vector information (Spatio-Temporal Predictor) or other prediction motion vector information may be used as the prediction motion vector information.

In the above embodiment, the H. 264/AVC system is basically used as the encoding system, but the present invention is not limited to this style. That is, the present invention may be applied to another encoding system/decoding system for executing motion vector information encoding processing using the differential processing. For example, the processing may be executed based on the differential value from the motion vector information in the block located at the left side as in the case of MPEG-2 as a method using correlation in the spatial direction.

The present invention may be applied to the image encoding device and the image decoding device used when image information (bit stream) compressed by the orthogonal transform such as the discrete cosine transform and the motion compensation is received through satellite broadcasting, a cable television, the Internet or a network medium such as a cellular phone as in the case of MPEG, H. 26x or the like. Furthermore, the present invention may be applied to the image encoding device and the image decoding device used when processing is executed on a storage medium such as optical, magnetic disk or a flash memory. Still furthermore, the present invention is applicable to a motion prediction compensation device contained in these image encoding device and image decoding device.

A series of processing described above may be executed by hardware or software. When the series of processing is executed by the software, a program constituting the software is installed in a computer. Here, the computer contains a computer installed in dedicated hardware or a general-purpose computer that can execute various kinds of functions by installing various kinds of programs in the computer.

### [Example of Construction of Personal Computer]

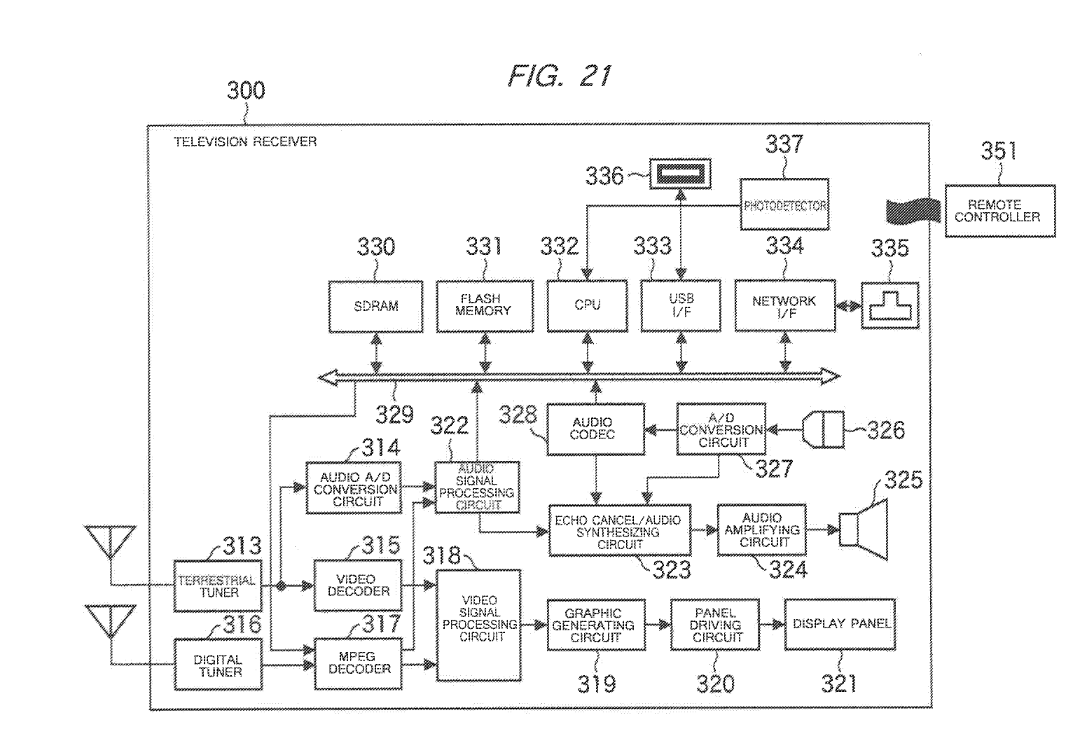

FIG. 20 is a block diagram depicting an example of the construction of hardware of a computer for executing the series of processing described above by a program.

In the computer, a CPU (Central Processing Unit) 201, a ROM (Read Only Memory) 202 and a RAM (Random Access Memory) 203 are mutually connected to one another through a bus 204.

An input/output interface 205 is connected to the bus 204. An input unit 206, an output unit 207, a storage unit 208, a communication unit 209 and a drive 210 are connected to the input/output interface 205.

The input unit 206 includes a keyboard, a mouse, a microphone and the like. The output unit 207 includes a display, a speaker and the like. The storage unit 208 includes a hard disk, a non-volatile memory or the like. The communication unit 209 includes a network interface or the like, the drive 210 drives a removable medium 211 such as a magnetic disk, an optical disk, a magnetooptical disk or a semiconductor memory.

In thus-constructed computer, the CPU 201 loads a program stored in the storage unit 208 through the input/output interface 205 and the bus 204 into the RAM 203 and executes the program to perform the series of processing described above.

The program executed by the computer (CPU 201) may be supplied with being recorded in a removable medium 211 such as a package medium or the like, for example. The program may be supplied through a wired or wireless transmission medium such as a local area network, the Internet or digital broadcasting.

In the computer, the program may be installed in the storage unit 208 through the input/output interface 205 by mounting the removable medium 211 into the drive 210. Furthermore, the program may be received by the communication unit 209 through the wired or wireless transmission medium, and installed into the storage unit 208. Alternatively, the program may be pre-installed in the ROM 202 or the storage unit 208.

The program executed by the computer may be programs processed in time-series along the order described in this specification, or programs processed in parallel or at such a required timing as calling or the like.

The embodiment of the present invention is not limited to the above embodiment, and various kinds of modifications may be made without departing from the subject of the present invention.

For example, the image encoding device 51 and the image decoding device 101 described above may be applied to any electronic equipment. Examples thereof will be described hereunder.

### [Example of Construction of Television Receiver]

FIG. 21 is a block diagram depicting an example of the main construction of a television receiver using the image decoding device to which the present invention is applied.

A television receiver 300 depicted in FIG. 21 has a terrestrial tuner 313, a video decoder 315, a video signal processing circuit 318, a graphic generating circuit 319, a panel driving circuit 320 and a display panel 321.

The terrestrial tuner 313 receives broadcast signals of terrestrial analog broadcast through an antenna, decodes the broadcast signals to obtain video signals, and supplies the video signal to the video decoder 315. The video decoder 315 subjects the video signals supplied from the terrestrial tuner 313 to decode processing, and supplies the obtained digital component signals to the video signal processing circuit 318.

The video signal processing circuit 318 subjects the video data supplied from the video decoder 315 to predetermined processing such as noise removal or the like, and supplies the obtained video data to the graphic generating circuit 319.

The graphic generating circuit 319 generates video data of a program displayed on the display panel 321, image data obtained by processing based on an application supplied through a network, and supplies the generated video data or image data to the panel driving circuit 320. The graphic generating circuit 319 arbitrarily executes the processing of generating video data (graphic) for displaying a screen used by a user through selection of items or the like, and supplies to the panel driving circuit 320 video data that are obtained by superimposing the generated video data on the video data of the program.

The panel driving circuit 320 drives the display panel 321 based on the data supplied from the graphic generating circuit 319 to display pictures of programs and various kinds of screens described above on the display panel 321.

The display panel 321 is constructed by an LCD (Liquid Crystal Display) or the like, and displays pictures of programs according to the control of the panel driving circuit 320.

Furthermore, the television receiver 300 also has an audio A/D (Analog/Digital) conversion circuit 314, an audio signal processing circuit 322, an echo cancel/audio synthesizing circuit 323, an audio amplifying circuit 324 and a speaker 325.

The terrestrial tuner 313 demodulates received broadcast signals to obtain not only video signals, but also audio signals. The terrestrial tuner 313 supplies the obtained audio signal to the audio A/D conversion circuit 314.

The audio A/D conversion circuit 314 subjects audio signals supplied from the terrestrial tuner 313 to A/D conversion processing, and supplies the obtained digital audio signals to the audio signal processing circuit 322.

The audio signal processing circuit 322 subjects the audio data supplied from the audio A/D conversion circuit 314 to predetermined processing such as noise removal, and supplies the obtained audio data to the echo cancel/audio synthesizing circuit 323.

The echo cancel/audio synthesizing circuit 323 supplies the audio data supplied from the audio signal processing circuit 322 to the audio amplifying circuit 324.

The audio amplifying circuit 324 subjects the audio data supplied from the echo cancel/audio synthesizing circuit 323 to the D/A conversion processing and the amplification processing so that the volume is adjusted to a predetermined volume, and then outputs sounds from the speaker 325.

Furthermore, the television receiver 300 has a digital tuner 316 and an MPEG decoder 317.

The digital tuner 316 receives broadcast signals of digital broadcast (terrestrial digital broadcast, BS (Broadcasting satellite)/CS (Communications Satellite) digital broadcast) through the antenna, decodes the broadcast signals to obtain MPEG-TS (Moving Picture Experts Group-Transport Stream), and supplies the MPEG-TS to the MPEG decoder 317.

The MPEG decoder 317 releases scramble applied to MPEG-TS supplied from the digital tuner 316, and extracts a stream containing data of a program as a reproduction target (viewing target). The MPEG decoder 317 decodes audio packets constituting the extracted stream, and supplies the obtained audio data to the audio signal processing circuit 322. In addition, the MPEG decoder 317 decodes video packets constituting the stream and supplies the obtained video data to the video signal processing circuit 318. The MPEG decoder 317 supplies EPG (Electronic Program Guide) data extracted from MPEG-TS through a path (not depicted) to a CPU 332.

The television receiver 300 uses the image decoding device 101 described above as the MPEG decoder 317 for decoding picture packets as described above. Accordingly, the MPEG decoder 317 suppresses increase of the processing amount and also enhance the coding efficiency when the prediction motion vector information is generated as in the case of the image decoding device 101.

The video data supplied from the MPEG decoder 317 are subjected to predetermined processing in the video signal processing circuit 318 as in the case of the video data supplied from the video decoder 315. The video data which have been subjected to the predetermined processing are arbitrarily superimposed on the generated video data or the like by the graphic generating circuit 319 and supplied to the display panel 321 through the panel driving circuit 320 to display the image thereof.

The audio data supplied from the MPEG decoder 317 are subjected to predetermined processing in the audio signal processing circuit 322 as in the case of the audio data supplied from the audio A/D conversion circuit 314. The audio data which have been subjected to the predetermined processing are supplied through the echo cancel/audio synthesizing circuit 323 to the audio amplifying circuit 324, and subjected to D/A conversion processing and amplification processing. As a result, sounds which are adjusted to a predetermined volume are output from the speaker 325.

Furthermore, the television receiver 300 also has a microphone 326 and an A/D conversion circuit 327.

The A/D conversion circuit 327 receives user's voice taken by the microphone 326 provided to the television receiver 300 for voice communication. The A/D conversion circuit 327 subjects the received audio signal to A/D conversion processing, and supplies the obtained digital audio data to the echo cancel/audio synthesizing circuit 323.

When the audio data of a user (user A) of the television receiver 300 are supplied from the A/D conversion circuit 327, the echo cancel/audio synthesizing circuit 323 executes echo cancel on the audio data of the user A. After the echo cancel, audio data obtained by combining the above audio data with other audio data or the like are output from the speaker 325 through the audio amplifying circuit 324 by the echo cancel/audio synthesizing circuit 323.

Furthermore, the television receiver 300 has an audio codec 328, an internal bus 329, an SDRAM (Synchronous Dynamic Random Access Memory) 330, a flash memory 331, the CPU 332, a USB (Universal Serial Bus) I/F 333, and a network I/F 334.

The A/D conversion circuit 327 receives a user's voice signal taken by the microphone 326 provided to the television receiver 300 for voice communication. The A/D conversion circuit 327 executes A/D conversion processing on the received audio signal, and supplies the obtained digital data to the audio codec 328.

The audio codec 328 converts the audio data supplied from the A/D conversion circuit 327 to data based on a predetermined format to transmit the data through a network, and supplies the data to the network I/F 334 through the internal bus 329.

The network I/F 334 is connected to the network through a cable mounted to a network terminal 335. The network I/F 334 transmits the audio data supplied from the audio codec 328 to another device connected to the network, for example. Furthermore, the network I/F 334 receives through the network terminal 335 audio data transmitted from another device connected through the network, and supplies the audio data concerned through the internal bus 329 to the audio codec 328.

The audio codec 328 converts the audio data supplied from the network I/F 334 to data of a predetermined format, and supplies the data concerned to the echo cancel/audio synthesizing circuit 323.

The echo cancel/audio synthesizing circuit 323 executes echo cancel on the targeted audio data supplied from the audio codec 328, and outputs from the speaker 325 through the audio amplification circuit 324 audio data obtained by combining the above audio data with another audio data or the like.

The SDRAM 330 stores various kinds of data required for the CPU 332 to perform the processing.

The flash memory 331 stores programs executed by the CPU 332. A program stored in the flash memory 331 is read by the CPU 332 at a predetermined timing such as a start-up time of the television receiver 300 or the like. EPG data obtained through digital broadcast, data obtained from a predetermined server through a network and the like are stored in the flash memory 331.

For example, MPEG-TS containing content data obtained from a predetermined server through a network is stored in the flash memory 331 under the control of the CPU 332. The flash memory 331 supplies the MPEG-TS through the internal bus 329 into the MPEG decoder 317 under the control of the CPU 332.

The MPEG decoder 317 processes the MPEG-TS as in the case of MPEG-TS supplied from the digital tuner 316. As described above, the television receiver 300 receives content data constructed by pictures, sounds or the like through the network and decodes them by using the MPEG decoder 317 so that the pictures thereof can be displayed or the sounds can be output.

Furthermore, the television receiver 300 has a photodetector 337 for photodetecting an infrared signal transmitted from a remote controller 351.

The photodetector 337 receives infrared rays from the remote controller 351, and outputs to the CPU 332 a control code which is obtained by decoding and represents the content of a user's operation.

The CPU 332 executes the program stored in the flash memory 331, and controls the overall operation of the television receiver 300 according to the control code supplied from the photodetector 337 and the like. The respective parts of the television receiver 300 are connected to the CPU 332 through a path (not depicted.

The USB I/F 333 receives/transmits data from/to external equipment of the television receiver 300 which is connected through a USB cable mounted to a USB terminal 336. The network I/F 334 is connected to a network through a cable mounted to the network terminal 335, and receives/transmit data other than audio data from/to various kinds of devices connected to the network.

The television receiver 300 can enhance the encoding efficiency by using the image decoding device 101 as the MPEG decoder 317. As a result, the television receiver 300 obtain higher definition decoded images from broadcast signals received through the antenna or content data obtained through the network, and display the decoded images.

### [Example of Construction of Cellular Phone]

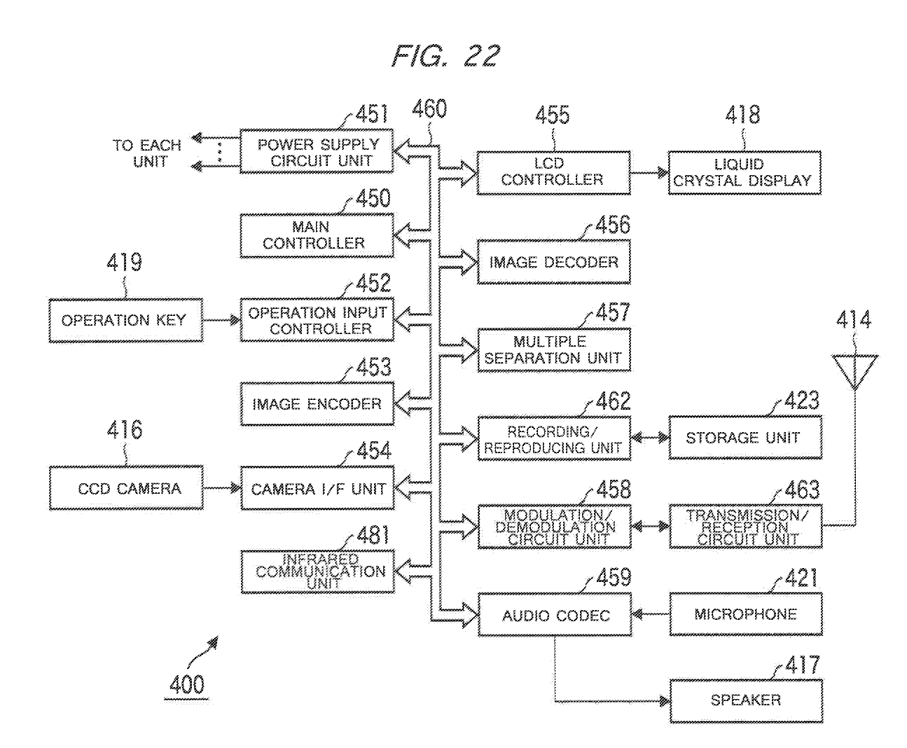

FIG. 22 is a block diagram depicting an example of the main construction of a cellular phone using the image encoding device and the image decoding device to which the present invention is applied.

A cellular phone 400 depicted in FIG. 22 has a main controller 450 for collectively controlling respective parts, a power supply circuit unit 451, an operation input controller 452, an image encoder 453, a camera I/F unit 454, an LCD controller 455, an image decoder 456, a multiple separation unit 457, a recording/reproducing unit 462, a modulation/demodulation circuit unit 458 and an audio codec 459. These are connected to one another through a bus 460.

The cellular phone 400 has an operation key 419, a CCD (Charge Coupled Devices) camera 416, a liquid crystal display 418, a storage unit 423, a transmission/reception circuit unit 463, an antenna 414, a microphone (mic) 421 and a speaker 417.

When a call-end and power supply key is set to an ON state by a user's operation, the power supply circuit unit 451 supplies power from a battery pack to respective parts to start up the cellular phone 400 so that the cellular phone is allowed to operate.

The cellular phone 400 performs various kinds of operations such as transmission/reception of audio signals, transmission/reception of electronic mails and image data, taking of images, data recording and the like in various kinds of modes such as a voice call mode, data communication mode and the like under the control of a main controller 450 constructed by a CPU, a ROM, a RAM and the like.

For example, in the voice call mode, the cellular phone 400 converts audio signals collected by the microphone (mic) 421 to digital audio data by an audio codec 459, subjects the digital audio data to spread spectrum processing in the modulation/demodulation circuit unit 458, and subjects the processed data to digital analog conversion processing and frequency conversion processing in the transmission/reception circuit unit 463. The cellular phone 400 transmits the transmission signal obtained through the conversion processing to a base station (not depicted) through an antenna 414. The transmission signal (audio signal) transmitted to the base station is supplied to a cellular phone of a communication partner through a public telephone network.

Furthermore, in the audio call mode, the cellular phone 400 amplifies a reception signal received by the antenna 414 by the transmission/reception circuit unit 463, subjects the signal concerned to frequency conversion processing and analog digital conversion processing, subjects the processed signal concerned to inverse spread spectrum processing in the modulation/demodulation circuit unit 458, and converts the signal to an analog audio signal by the audio codec 459. The cellular phone 400 outputs the thus-converted analog audio signal from the speaker 417.

Furthermore, for example when an electronic mail is transmitted in the data communication mode, the cellular phone 400 accepts the text data of the electronic mail input through the operation of the operation key 419 by the operation input controller 452. The cellular phone 400 processes the text data in the main controller 450, and displays the text data as an image on the liquid crystal display 418 through the LCD controller 455.

Furthermore, the cellular phone 400 generates electronic mail data based on the text data accepted by the operation input controller 452, a user's instruction and the like in the main controller 450. The cellular phone 400 subjects the electronic mail data to spread spectrum processing in the modulation/demodulation circuit unit 458, and subjects the processed data to digital analog conversion processing and frequency conversion processing in the transmission/reception circuit unit 463. The cellular phone 400 transmits the transmission signal obtained through the conversion processing through the antenna 414 to a base station (not depicted). The transmission signal (electronic mail) transmitted to the base station is supplied to a predetermined destination through a network, a mail server and the like.

Furthermore, when an electronic mail is received in the data communication mode, the cellular phone 400 receives a signal transmitted from the base station through the antenna 414 by the transmission/reception circuit unit 463, amplifies the signal and further subjects the amplified signal to frequency conversion processing and analog digital conversion processing. The cellular phone 400 subjects the reception signal to inverse spread spectrum processing in the modulation/demodulation circuit unit 458 to restore the original electronic mail data. The cellular phone 400 displays the restored electronic mail data through the LCD controller 455 on the liquid crystal display 418.

The cellular phone 400 may record (store) the received electronic mail data through the recording/reproducing unit 462 into the storage unit 423.

This storage unit 423 is any rewritable storage medium. The storage unit 423 may be a semiconductor memory such as a RAM or a built-in type flash memory, a hard disk or a removable medium such as a magnetic disk, a magnetooptical disk, an optical disk, a USB memory or a memory card. It is needless to say that the storage unit may be anything other than the above materials.

Furthermore, for example, when image data are transmitted in the communication mode, the cellular phone 400 generates image data by taking an image with a CCD camera 416. The CCD camera 416 has optical devices such as a lens and a diaphragm and CCD such as a photoelectric conversion element, takes an image of a subject and converts the intensity of photodetected light to an electrical signal to generate image data of an image of the subject. The image data are subjected to compression encoding according to a predetermined encoding system such as MPEG2 or MPEG4 by the image encoder 453 through the camera I/F unit 454, whereby the image data are converted to encoded image data.

The cellular phone 400 uses the foregoing image encoding device 51 as the image encoder 453 for performing the processing as described above. Accordingly, the image encoder 453 can suppress the increase of the processing amount and enhance the coding efficiency when the prediction motion vector information is generated as in the case of the image encoding device 51.

At the same time, the cellular phone 400 simultaneously subjects the sounds collected by the microphone (mic) 421 to analog digital conversion in the audio codec 459 during the imaging operation of the CCD camera 416, and further encodes the processed sounds.

The cellular phone 400 multiplexes the encoded image data supplied from the image encoder 453 and the digital audio data supplied from the audio codec 459 in a predetermined format in the multiple separation unit 457. The cellular phone 400 subjects the resultant multiplexed data to spread spectrum processing in the modulation/demodulation circuit unit 458, and subjects the processed data to digital analog conversion processing and frequency conversion processing in the transmission/reception circuit unit 463. The cellular phone 400 transmits the transmission signal obtained through the conversion processing to the base station (not depicted) through the antenna 414. The transmission signal (image data) transmitted to the base station are supplied to a communication partner through a network or the like.

When no image data is transmitted, the cellular phone 400 may display the image data generated by the CCD camera 416 not through the image encoder 453, but through the LCD controller 455 on the liquid crystal display 418.

Furthermore, in the data communication mode, when data of a moving picture file linked to a simple homepage or the like are received, the cellular phone 400 receives a signal transmitted from the base station through the antenna 414 by the transmission/reception circuit unit 463, amplifies the processed signal and further subjects the amplified signal to the frequency conversion processing and the analog digital conversion processing. The cellular phone 400 subjects the reception signal to the inverse spread spectrum processing in the modulation/demodulation circuit unit 458 to restore the original multiplexed data. The cellular phone 400 separates the multiplexed data into the encoded image data and the audio data in the multiple separation unit 457.

The cellular phone 400 decodes the encoded image data according to a decoding system corresponding to a predetermined encoding system such as MPEG2 or MPEG4 in the image decoder 456 to thereby generate reproduced moving picture data, and displays the reproduced moving image data on the liquid crystal display 418 through the LCD controller 455. Accordingly, the moving picture data contained in a moving picture file linked to a simple homepage are displayed on the liquid crystal display 418.

The cellular phone 400 uses the above image decoding device 101 as the image decoder 456 for performing the processing as described above. Accordingly, the image decoder 456 can suppress the increase of the processing amount and enhance the coding efficiency when the prediction motion vector information is generated in the case of the image decoding device 101.

At this time, the cellular phone 400 simultaneously converts the digital audio data to an analog audio signal in the audio codec 459, and outputs the analog audio signal from the speaker 417. Accordingly, the audio data contained in the moving picture file linked to the simple homepage are reproduced, for example.

As in the case of the electronic mail, the cellular phone 400 can record (store) the received data linked to the simple homepage or the like into the storage unit 423 through the recording/reproducing unit 462.

Furthermore, the cellular phone 400 can analyze a two-dimensional code imaged and obtained by the CCD camera 416 in the main controller 450, and obtain information recorded in the two-dimensional code.

Still furthermore, the cellular phone 400 can communicate with external equipment with infrared rays by the infrared communication unit 481.

The cellular phone 400 can enhance the coding efficiency by using the image encoding device 51 as the image encoder 453. As a result, the cellular phone 400 can supply another device with encoded data (image data) having a high coding efficiency.

Furthermore, the cellular phone 400 can enhance the coding efficiency by using the image decoding device 101 as the image decoder 456. As a result, the cellular phone 400 can obtain a higher definition decoded image from the moving image file linked to the simple homepage and display the image.

In the foregoing description, the cellular phone 400 uses the CCD camera 416. However, an image sensor (CMOS image sensor) using CMOS (Complementary Metal Oxide Semiconductor) may be used in place of the CCD camera 416, in this case, the cellular phone 400 can take an image of a subject and generate image data of the image of the subject as in the case of the CCD camera 416.

The cellular phone 400 is used in the foregoing description. However, as in the case of the cellular phone 400, the image encoding device 51 and the image decoding device 101 may be applied to any device such as PDA (Personal Digital Assistants), a smart phone, UMPC (Ultra Mobile Personal Computer), a net book, a notebook personal computer or the like insofar as the device has the same imaging function and communication function as the cellular phone 400.

### [Example of Construction of Hard Disk Recorder]

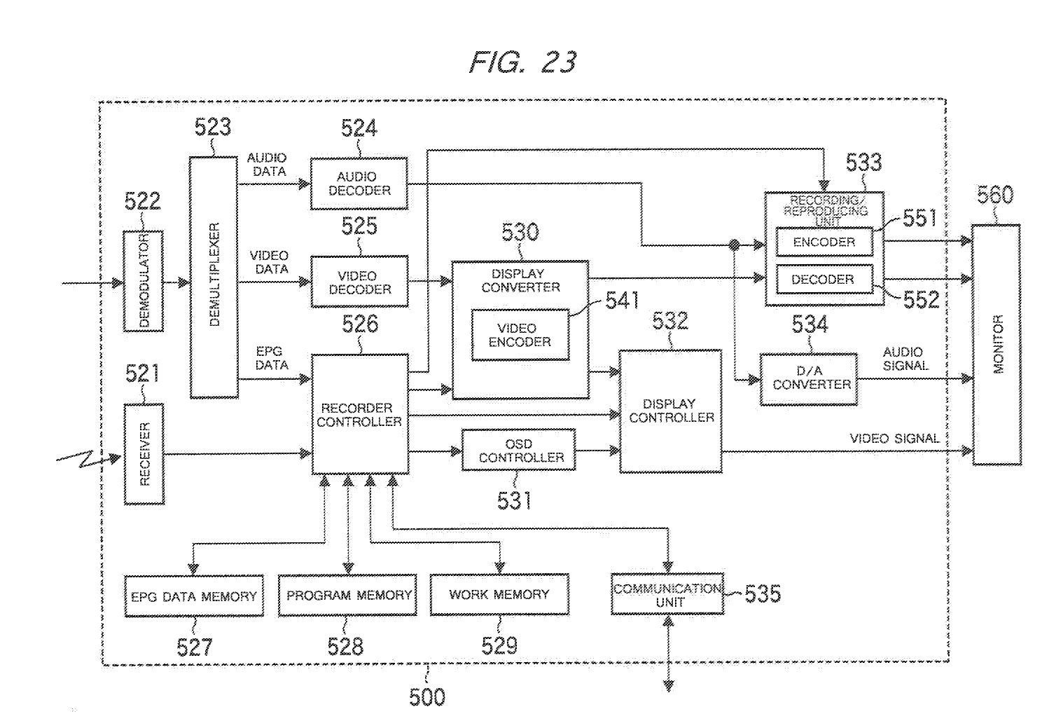

FIG. 23 is a block diagram depicting an example of the main construction of a hard disk recorder using the image encoding device and the image decoding device to which the present invention is applied.

A hard disk recorder (HDD recorder) 500 depicted in FIG. 23 is a device for storing, into a built-in hard disk, audio data and video data of a broadcast program contained in a broadcast signal (television signal) which is received by a tuner and transmitted from a satellite or terrestrial antenna or the like, and supplying a user with the stored data at a timing instructed by the user.

For example, the hard disk recorder 500 can extract audio data and video data from a broadcast signal, arbitrarily decode the audio data and the video data and store these data into the built-in hard disk. Furthermore, the hard disk recorder 500 can also obtain audio data and video data from another device through a network, arbitrarily decode these data and store the data into the built-in hard disk.

Furthermore, the hard disk recorder 500 decodes the audio data and the video data stored in the built-in hard disk, supplies the data to a monitor 560 and displays the image thereof on a screen of the monitor 560, for example. The hard disk recorder 500 may output the sounds thereof from a speaker of the monitor 560.

The hard disk recorder 500 decodes audio data and video data extracted from a broadcast signal obtained through the tuner or audio data and video data obtained from another device through a network, and supplies these data to the monitor 560 to display the image thereof on the screen of the monitor 560. Furthermore, the hard disk recorder 500 can output the sounds of the data from the speaker of the monitor 560.

Of course, other operations may be performed.

As shown in FIG. 23, the hard disk recorder 500 has a receiver 521, a demodulator 522, a demultiplexer 523, an audio decoder 524, a video decoder 525 and a recorder controller 526. The hard disk recorder 500 further has an EPG data memory 527, a program memory 528, a work memory 529, a display converter 530, OSD (On Screen Display) controller 531, a display controller 532, a recording/reproducing unit 533, a D/A converter 534 and a communication unit 535.

The display converter 530 has a video encoder 541. The recording/reproducing unit 533 has an encoder 551 and a decoder 552.

The receiver 521 receives an infrared signal from a remote controller (not depicted), converts the signal to an electrical signal and outputs the electrical signal to the recorder controller 526. The recorder controller 526 is constructed by a micro processor or the like, and executes various kinds of processing according to programs stored in the program memory 528. At this time, the recorder controller 526 uses the work memory 529 as occasion demands.

The communication unit 535 is connected to a network and perform communication processing with another device through the network. For example, the communication unit 535 is controlled by the recorder controller 526 to communicate with a tuner (not shown) and mainly output a tuning control signal to the tuner.

The demodulator 522 decodes a signal supplied from the tuner and outputs the decoded signal to the demultiplexer 523. The demultiplexer 523 separates the data supplied from the demodulator 522 into audio data, video data and EPG data, and outputs these data to the audio decoder 524, the video decoder 525 or the recorder controller 526.

the audio decoder 524 decodes the input audio data according to the MPEG system, for example, and outputs the decoded audio data to the recording/reproducing unit 533. The video decoder 525 decodes the input video data according to the MPEG system, for example, and outputs the decoded video data to the display converter 530. The recorder controller 526 supplies and stores the input EPG data into the EPG data memory 527.

The display converter 530 encodes the video data supplied from the video decoder 525 or the recorder controller 526 to video data based on, for example, NTSC (National Television Standards Committee) system by the video encoder 541, outputs the encoded data to the recording/reproducing unit 533. Furthermore, the display converter 530 converts the screen size of the video data supplied from the video decoder 525 or the recorder controller 526 to the size corresponding to the size of the monitor 560. The display converter 530 further converts the screen-size-converted video data to video data of the NTSC system by the video encoder 541, converts the thus-converted video signal of the NTSC system to an analog signal, and output the analog signal to the display controller 532.

The display controller 532 superimposes the OSD signal output from the OSD (On Screen Display) controller 531 onto the video signal input from the display converter 530 under the control of the recorder controller 526, and outputs the superimposed signals to the display of the monitor 560 to display the signals on the display.

The audio data output from the audio decoder 524 are converted to an analog signal by the D/A converter 534 and supplied to the monitor 560. The monitor 560 outputs this audio signal from the built-in speaker.

The recording/reproducing unit 533 has a hard disk as a recording medium for recording video data, audio data and the like.

For example, the recording/reproducing unit 533 encodes the audio data supplied from the audio decoder 524 according to the MPEG system by the encoder 551. Furthermore, the recording/reproducing unit 533 encodes the video data supplied form the video encoder 541 of the display converter 530 according to the MPEG system by the encoder 551. The recording/reproducing unit 533 combines the encoded data of the audio data and the encoded data of the video data by the multiplexer. The recording/reproducing unit 533 subjects the composite data concerned to channel coding and amplification, and writes the data into the hard disk through a recording head.

The recording/reproducing unit 533 reproduces data recorded in the hard disk through a reproducing head, amplifies the data and separates the data into audio data and video data by the demultiplexer. The recording/reproducing unit 533 decodes the audio data and the video data according to the MPEG system by the decoder 552. The recording/reproducing unit 533 D/A-converts the decoded audio data, and outputs the audio data to the speaker of the monitor 560. Furthermore, the recording/reproducing unit 533 D/A-converts the decoded video data, and outputs the video data to the display of the monitor 560.

The recorder controller 526 reads the latest EPG data from the EPG data memory 527 based on a user instruction represented by an infrared signal from the remote controller which is received through the receiver 521, and supplies the latest EPG data to the OSD controller 531. The OSD controller 531 generates image data corresponding to the input EPG data, and outputs the image data to the display controller 532. The display controller 532 outputs the video data input from the OSD controller 531 to the display of the monitor 560 to display the video data. Accordingly, EPG (electronic program guide) is displayed on the display of the monitor 560.

Furthermore, the hard disk recorder 500 can obtain various kinds of data such as video data, audio data and EPG data supplied from another device through a network such as the Internet.

The communication unit 535 is controlled by the recorder controller 526, obtains encoded data such as video data, audio data and EPG data transmitted from another device through the network and supplies these data to the recorder controller 526. The recorder controller 526 supplies the encoded data of the obtained video data and audio data to the recording/reproducing unit 533 to store these data into the hard disk. At this time, the recorder controller 526 and the recording/reproducing unit 533 may perform the processing such as re-encoding as occasion demands.

Furthermore, the recorder controller 526 decodes the encoded data of the obtained video data and audio data, and supplies the obtained video data to the display converter 530. As in the case of the video data supplied from the video decoder 525, the display converter 530 processes the video data supplied from the recorder controller 526, and supplies the processed video data to the monitor 560 through the display controller 532 to display the image thereof.

In combination with this image display, the recorder controller 526 may supply the decoded audio data to the monitor 560 through the D/A converter 534, and output the sounds thereof from the speaker.

Furthermore, the recorder controller 526 decodes the encoded data of the obtained EPG data, and supplies the decoded EPG data to the EPG data memory 527.

The hard disk recorder 500 as described above uses the image decoding device 101 as the video decoder 525, the decoder 552 and the decoder contained in the recorder controller 526. Accordingly, as in the case of the image decoding device 101, the video decoder 525, the decoder 552 and the decoder contained in the recorder controller 526 can suppress the increase of the processing amount and enhance the coding efficiency when prediction motion vector information is generated.

Accordingly, the hard disk recorder 500 can generate prediction images of high precision. As a result, the hard disk recorder 500 obtains decoded images of higher definition from the encoded data of the video data received through the tuner, the encoded data of the video data read from the hard disk of the recording/reproducing unit 533 and the encoded data of the video data obtained through the network, and display these data on the monitor 560.

The hard disk recorder 500 uses the image encoding device 51 as the encoder 551. Accordingly, as in the case of the image encoding device 51, the encoder 551 can suppress the increase of the processing amount and enhance the coding efficiency when the prediction motion vector information is generated.

Accordingly, the hard disk recorder 500 can the coding efficiency of the encoded data recorded in the hard disk, for example. As a result, the hard disk recorder 500 can use the storage area of the hard disk more efficiently.

The above description is made on the hard disk recorder 500 for recording the video data and the audio data in the hard disk. Of course, any recording medium may be used. For example, the image encoding device 51 and the image decoding device 101 may be applied to even a recorder to which a recording medium other than the hard disk, such as a flash memory, an optical disk or a video tape is applied as in the case of the hard disk recorder 500 described above.

### [Example of Construction of Camera]

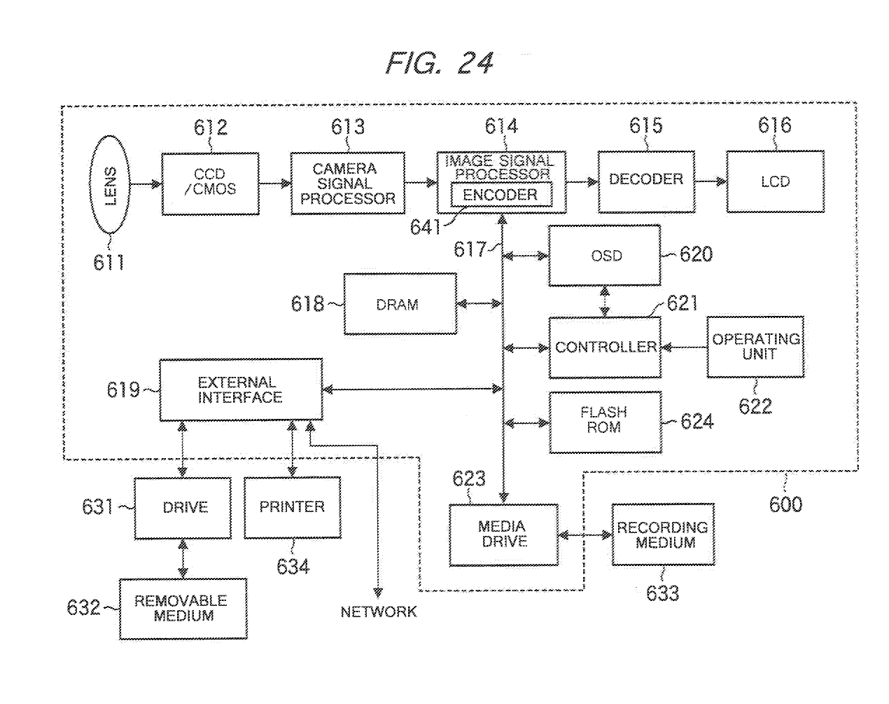

FIG. 24 is a block diagram depicting an example of the main construction of a camera using the image decoding device and the image encoding device to which the present invention is applied.

The camera 600 depicted in FIG. 24 images a subject, displays the image of the subject on an LCD 616 and records the image data thereof in a recording medium 633.

A lens block 611 makes light (that is, an image of the subject) incident to a CCD/CMOS 612. The CCD/CMOS 612 is an image sensor using a CCD or a CMOS, and it converts the intensity of received light to an electrical signal and supplies the electrical signal to a camera signal processor 613.

The camera signal processor 613 converts the electrical signal supplied from the CCD/CMOS 612 to color difference signals of Y, Cr, Cb, and supplies the color difference signals to an image signal processor 614. Under the control of a controller 621, the image signal processor 614 executes predetermined image processing on the image signal supplied from the camera signal processor 613, and encodes the image signal, for example, according to the MPEG system by the encoder 641. The image signal processor 614 encodes the image signal, and supplies the generated encoded data to the decoder 615. Furthermore, the image signal processor 614 obtains display data generated in an on-screen display (OSD) 620, and supplies the display data to the decoder 615.

In the above processing, the camera signal processor 613 arbitrarily uses a DRAM (Dynamic Random Access Memory) 618 connected thereto through a bus 617, and makes the DRAM 618 hold the image data, the encoded data obtained by encoding the image data concerned and the like as occasion demands.

The decoder 615 decodes the encoded data supplied from the image signal processor 614, and supplies the obtained image data (decoded image data) to the LCD 616. Furthermore, the decoder 615 supplies the LCD 616 with display data supplied from the image signal processor 614. The LCD 616 arbitrarily combines the image of the decoded image data supplied from the decoder 615 and the image of the display data, and displays the composite image concerned.

Under the control of the controller 621, the on-screen display 620 outputs display data such as a menu screen containing symbols, characters or figures and icons to the image signal processor 614 through the bus 617.

The controller 621 executes various kinds of processing based on a signal representing a content which is instructed with an operating unit 622 by a user, and controls through the bus 617 the image signal processor 614, the DRAM 618, an external interface 619, the on-screen display 620, a media drive 623 and the like. Programs, data and the like which are required for the controller 621 to execute various kinds of processing are stored in a FLASH ROM 624.

For example, the controller 621 can encode image data stored in the DRAM 618 and decode encoded data stored in the DRAM 618 in place of the image signal processor 614 and the decoder 615. At this time, the controller 621 may perform the encoding/decoding processing according to the same system as the encoding/decoding system of the image signal processor 614 or the decoder 615, or perform the encoding/decoding processing according to a system to which the image signal processor 614 and the decoder 615 is not adapted.

For example when start of image print is instructed from the operating unit 622, the controller 621 reads image data from the DRAM 618, and supplies the image data through the bus 617 to a printer 634 connected to the external interface 619 to print the image data.

Furthermore, for example when image recording is instructed from the operating unit 622, the controller 621 reads encoded data from the DRAM 618, and supplies the encoded data through the bus 617 to a recording medium 633 mounted in the media drive 623.

The recording medium 633 is any readable and writable removable medium such as a magnetic disk, a magnetooptical disk, an optical disk or a semiconductor memory. The recording medium 633 may be any kind of removable medium, a tape device, a disk or a memory card. It is needless to say that the recording medium 633 may be a contactless IC card or the like.

Furthermore, the media drive 623 and the recording medium 633 may be integrated with each other, and constructed by a non-portable storage medium such as a built-in hard disk drive or SSD (Solid State Drive), for example.

The external interface 619 is constructed by a USB input/output terminal or the like, for example, and it is connected to the printer 634 when an image is printed. A drive 631 is connected to the external interface 619 as occasion demands, and a removable medium 632 such as a magnetic disk, an optical disk or a magnetooptical disk is arbitrarily mounted in the external interface 619. A computer program read from the removable medium 632 is installed into the FLASH ROM 624 as occasion demands.

Furthermore, the external interface 619 has a network interface connected to a predetermined network such as LAN or the Internet The controller 621 may read encoded data from the DRAM 618 according to an instruction from the operating unit 622, for example, and supply the encoded data from the external interface 619 to another device connected through the network. Furthermore, the controller 621 can obtain through the external interface 619 encoded data or image data supplied from another device through the network, and make the DRAM 618 hold these data or supply these data to the image signal processor 614.

The camera 600 as described above uses the image decoding device 101 as the decoder 615. Accordingly, as in the case of the image decoding device 101, the decoder 615 can suppress the increase of the processing amount and enhance the coding efficiency when prediction motion vector information is generated.

Accordingly, the camera 600 can generate a prediction image of high precision. As a result, the camera 600 can obtain a decoded image of higher definition from image data generated in the CCD/CMOS 612, encoded data of video data read from the DRAM 618 or the recording medium 633 or encoded data of video data obtained through the network, and display the decoded image on the LCD 616.

Furthermore, the camera 600 uses the image encoding device 51 as the encoder 641. Accordingly, as in the case of the image encoding device 51, the encoder 641 can suppress the increase of the processing amount and enhance the coding efficiency when prediction motion vector information is generated.

Accordingly, the camera 600 can enhance the coding efficiency of encoded data recorded in the hard disk, for example. As a result, the camera 600 can more efficiently use the storage area of the DRAM 618 or the recording medium 633.

The decoding method of the image decoding device 101 may be applied to the decoding processing executed by the controller 621. Likewise, the encoding method of the image encoding device 51 may be applied to the encoding processing executed by the controller 621.

Furthermore, the image data taken by the camera 600 may be moving pictures or still images.

It is needless to say that the image encoding device 51 and the image decoding device 101 may be applied to devices and systems other than the foregoing devices.

### REFERENCE SIGNS LIST

51 Image encoding device
66 Lossless encoder
74 Intra prediction unit
75 Motion prediction/compensation unit
76 Motion vector information encoder
81 Motion searching unit
82 Cost function calculator
83 Mode determining unit
84 Motion compensation unit
91 Median prediction unit
92 Differential motion vector generator
93 Secondary differential motion vector generator
101 Image decoding device
112 Lossless decoder
121 Intra prediction unit
122 Motion compensation unit
123 Motion vector information decoder
131 Secondary differential motion vector information buffer
132 Motion vector information buffer
133 Differential motion vector information buffer
134 Motion compensation unit
141 Median prediction unit
142 Motion vector information generator

1. An image processing apparatus comprising:
differential motion vector generating means that generates differential motion vector information of an encoding target block in an encoding target frame corresponding to a difference between motion vector information searched for the encoding target block in the encoding target frame and prediction motion vector information of the encoding target block; and
secondary differential motion vector generating means that generates secondary differential motion vector information corresponding to a difference between differential motion vector information of the encoding target block generated by the differential motion vector generating means and differential motion vector information of a corresponding block that is a block of a reference frame and located at a position corresponding to the encoding target block.

2. The image processing apparatus according to claim 1, further comprising prediction motion vector generating means that generates prediction motion vector information of the encoding target block according to median prediction in the encoding target frame.

3. The image processing apparatus according to claim 1, wherein the secondary differential motion vector generating means generates the secondary differential motion vector information while the differential motion vector information of the corresponding block is set to zero when the corresponding block is an intra-predicted block.

4. The image processing apparatus according to claim 1, further comprising:
encoding means that encodes the secondary differential motion vector information generated by the secondary differential motion vector generating means and an image of the encoding target block; and
transmitting means that transmits the secondary differential motion vector information and the image of the encoding target block which have been encoded by the encoding means.

5. The image processing apparatus according to claim 1, further comprising:
encoding means that selects any one of the differential motion vector information of the encoding target block generated by the differential motion vector generating means and the secondary differential motion vector information generated by the secondary differential motion vector generating means, and encodes the selected information and the image of the encoding target block; and
transmitting means that transmits the information and the image of the encoding target block which have been encoded by the encoding means.

6. The image processing apparatus according to claim 5, wherein the transmitting means further transmits flag information as to which one of the differential motion vector information of the encoding target block and the secondary differential motion vector information has been selected and encoded.

7. The image processing apparatus according to claim 5, wherein the encoding means adaptively selects one of the differential motion vector information of the encoding target block and the secondary differential motion vector information.

8. The image processing apparatus according to claim 5, wherein the encoding means selects any one of the differential motion vector information of the encoding target block and the secondary differential motion vector information in accordance with a profile in an encoding parameter.

9. An image processing method to be performed by an image processing apparatus having differential motion vector generating means and secondary differential motion vector generating means, the method comprising:
generating, by the differential motion vector generating means, differential motion vector information of an encoding target block in an encoding target frame corresponding to a difference between motion vector information searched for the encoding target block in the encoding target frame in the encoding target frame and prediction motion vector information of the encoding target block; and
generating, by the secondary differential motion vector generating means, secondary differential motion vector information corresponding to a difference between differential motion vector information of the encoding target block generated by the differential motion vector generating means and differential motion vector information of a corresponding block that is a block of a reference frame and located at a position corresponding to the encoding target block.

10. An image processing apparatus comprising:
receiving means that receives an image of a decoding target block in a decoding target frame and secondary differential motion vector information; and
motion vector generating means that generates motion vector information of the decoding target block by using the secondary differential motion vector information received by the receiving means, prediction motion vector information of the decoding target block and differential motion vector information of a corresponding block that is a block of a reference frame and located at a position corresponding to the encoding target block.

11. The image processing apparatus according to claim 10, further comprising prediction motion vector generating means that generates prediction motion vector information of the decoding target block according to median prediction in the decoding target frame.

12. The image processing apparatus according to claim 10, wherein the motion vector generating means generates the motion vector information of the decoding target block while the differential motion vector information of the corresponding block is set to zero when the corresponding block is an intra-predicted block.

13. The image processing apparatus according to claim 10, wherein the receiving means further receives flag information as to which one of the differential motion vector information of the decoding target block and the secondary differential motion vector information has been encoded, and receives the secondary differential motion vector information when the flag information represents that the secondary differential motion vector information has been encoded.

14. The image processing apparatus according to claim 13, wherein the receiving means receives the differential motion vector information when the flag information represents that the differential motion vector information of the decoding target block is encoded, and
the motion vector generating means generates the motion vector information of the decoding target block by using the differential motion vector information of the decoding target block received by the receiving means and the prediction motion vector information of the decoding target block generated by the prediction motion vector generating means.

15. The image processing apparatus according to claim 13, wherein any one of the differential motion vector information of the decoding target block and the secondary differential motion vector information is adaptively selected and encoded.

16. The image processing apparatus according to claim 13, wherein any one of the differential motion vector information of the decoding target block and the secondary differential motion vector information is selected and encoded in accordance with a profile in an encoding parameter.

17. An image processing method to be performed by an image processing apparatus having receiving means and motion vector generating means, the method comprising:
receiving, by the receiving means, an image of a decoding target block in a decoding target frame and secondary differential motion vector information; and
generating, by the motion vector generating means, motion vector information of the decoding target block by using the received secondary differential motion vector information, prediction motion vector information of the decoding target block, and differential motion vector information of a corresponding block that is a block of a reference frame and located at a position corresponding to the encoding target block.
